(19) United States
(12) Patent Application Publication
(10) Pub. No.: US 2024/0122793 A1
(43) Pub. Date: Apr. 18, 2024

(54) COMPACT MASSAGERS

(71) Applicant: ADDADAY, INC., Los Angeles, CA (US)

(72) Inventors: Victor YANG, Los Angeles, CA (US); Leo Boris MARZOLF, Los Angeles, CA (US); David Jason WILKINS, Los Angeles, CA (US); Robyn ALLEY, Los Angeles, CA (US); Nikolay Sergeyevich VLADIMIROV, Los Angeles, CA (US); Marcelle Nadine Yvette VAN BEUSEKOM, Los Angeles, CA (US); Juho Tapio PARVIAINEN, Los Angeles, CA (US); Nikolaj Dam ROADLEY-BATTIN, Los Angeles, CA (US)

(21) Appl. No.: 18/346,281

(22) Filed: Jul. 3, 2023

Related U.S. Application Data
(63) Continuation of application No. PCT/IB2022/050054, filed on Jan. 5, 2022.
(60) Provisional application No. 63/148,542, filed on Feb. 11, 2021.
(60) Provisional application No. 63/245,403, filed on Sep. 17, 2021.
(60) Provisional application No. 63/133,971, filed on Jan. 5, 2021.

(30) Foreign Application Priority Data
Apr. 21, 2021 (CN) 202120831357X
Apr. 21, 2021 (CN) 2021208310529

(51) Int. Cl. A61H 23/00

(52) U.S. Cl. CPC A61H 23/006; A61H 2201/0107; A61H 2201/0119; A61H 2201/0165; A61H 2201/0169; A61H 2201/0188; A61H 2201/0192; A61H 2201/1215; A61H 2201/1418; A61H 2201/1436; A61H 2201/149; A61H 2201/1669; A61H 2201/5046; A61H 2201/5048; A61H 2201/5097

(57) ABSTRACT

In certain example embodiments, provided is a compact massager, comprising: (1) one or more massage head attachment portions; and (2) a massager body, wherein the massager body is configured to connect with the one or more massage head attachment portions at the front body side, the massager body further comprises: (i) a motor; (ii) a PCBA; (iii) a display; (iv) a power source; wherein the power source is configured to electrically connect with the motor, the PCBA and the display; (v) a Z-shaped, transmission crank, configured to translate rotary motion from the motor to reciprocating motion of the one or more massage head attachment portions; and (vi) a counterweight, having an eccentric cam, an input shaft and an output shaft, wherein the input shaft is disposed at one side of the cam and is operatively connected to the motor, and an output shaft is disposed at an opposing side of the cam and is operatively connected to the transmission crank. In certain example embodiments, the compact massager provides comparable or even stronger or deeper massage despite the size being relatively smaller and the noise level is reduced.

### FIELD OF INVENTION

The present disclosure relates generally to the field of massage devices, and more specifically to compact massagers.

### BACKGROUND

Massages and related types of physical therapy are regularly used by many individuals, whether to provide relief from muscle aches and pains or to simply aid in relaxation and stress relief. In particular, motorized massage therapy devices, such as massage wands, percussion massagers, and massage chairs, have become increasingly popular for such purposes.

However, currently existing massage therapy devices are large, bulky, and heavy (not being compact enough); have an aggressive mechanical action; only access certain parts of the body; and are difficult for users to learn how to use most effectively—all of which negatively impact the user experience. An improved massager is highly desired.

### SUMMARY OF INVENTION

In the light of the foregoing background, in certain example embodiments, it is an object to provide an improved massager that provides an improved massager experience. In certain example embodiments, the intelligent massage therapy devices, methods, and systems disclosed herein relate to an intelligent massage therapy device and methods of using the same. In some embodiments, the intelligent massage therapy device is a compact massager having a Z-shaped (or lazy-Z-shaped) crank, motor mounting points, an automatically darkening display, a motor counterweight, a removeable extension handle that, in some embodiments, allows for access to all areas of the body, an induction charging docking station that also contains and conceals the massage heads, pressure activated pause mode, Wi-Fi and Bluetooth capability, and a user-friendly, full color touch screen display configured to display instructions delivered in video and audio formats relating to recommended uses of the device as well as information relating to current use of the device.

An exemplary embodiment of the present disclosure is a massager comprising: a power source; a motor; a counterweight cam; a transmission shaft; mechanism wherein the motor mechanism comprises a shaft that is lazy Z-shaped; a housing; one or more massage head attachment portions; and a display.

In another exemplary embodiment, provided is a massager comprising: a rechargeable battery; a motor; a counterweight cam; a transmission shaft that is lazy Z-shaped; mechanism wherein the motor mechanism comprises a shaft that is lazy Z-shaped; a housing; a piston; an operations button; one or more damping elements; one or more massage head attachment portions; and a display; wherein the transmission shaft is lazy Z-shaped; wherein the battery and the motor are on opposite ends of the massager; and wherein the motor is operatively connected to the counterbalance cam, which is operatively connected to the transmission shaft, which is operatively connected to the piston, which is operatively connected to one of the one or more massage head attachment portions.

In another exemplary embodiment, provided is a compact massager, comprising: (1) one or more massage head attachment portions; and (2) a massager body, having a top body end, and an opposing, bottom body end defining a length therebetween, and a front body side and a rear body side defining a cross-section therewithin, wherein the massager body is configured to connect with the one or more massage head attachment portions at the front body side, the massager body further comprises: (i) a motor, disposed proximate to the top body end; (ii) a PCBA, disposed proximate to the bottom body end; (iii) a display, disposed at the rear body side; (iv) a power source, disposed proximate to the bottom body end; wherein the power source is configured to electrically connect with the motor, the PCBA and the display; (v) a Z-shaped, transmission crank, configured to translate rotary motion from the motor to reciprocating motion of the one or more massage head attachment portions; and (vi) a counterweight, having an eccentric cam, an input shaft and an output shaft, wherein the input shaft is disposed at one side of the cam and is operatively connected to the motor, and an output shaft is disposed at an opposing side of the cam and is operatively connected to the transmission crank.

In another exemplary embodiment, provided is a compact massager, having a top end and a bottom end defining a length therebetween, a front side and a rear side defining a cross-section therewithin, comprising: a rechargeable battery, disposed proximate to the bottom end; a motor, disposed proximate to the top end; a counterweight; a transmission crank that is Z-shaped; a housing having substantially overall cross-section for the massager body along the length; a piston; an operations button; one or more damping pads; one or more massage head attachment portions; and a display; wherein the battery is configured to electrically connect with the motor, the operations button and the display; and wherein the motor is operatively connected to the counterweight, which is operatively connected to the transmission crank, which is operatively connected to the piston, which is operatively connected to one of the one or more massage head attachment portions.

Other example embodiments are discussed herein.

There are many advantages to the present disclosure. In certain example embodiments, the compact massager is compact in design, making it sleek and attractive. In certain example embodiments, the compact massager is easy to use and user-friendly. In certain example embodiments, the massager and extension handles are light and easy and comfortable to hold, improving user experience. In certain example embodiments, the compact massager provides comparable or even stronger or deeper massage despite the size being relatively smaller. In certain example embodiments, the noise level of the compact massager is greatly reduced. In certain example embodiments, provided is a smart, modular, and adaptable massage therapy device capable of pressure-activated percussion, modulating vibration frequencies, attachable extension handle, Wi-Fi and Bluetooth connectivity, audio guidance and a user-friendly touch screen display with full color video capability to visually and audibly provide instructions for device use and settings relating to device settings.

In various embodiments, the massager device and system may comprise:
One or more extension handles with ‘Snap-On’ magnetic connection, and handle shapes consistent with rest of device for seamless aesthetic, multiple shapes, and improved user ergonomics.
Docking station is attractive and hides and protects the massage tip when device is docked.
Matching docking station/device size (length/width) and color scheme provide the aesthetic of one cohesive unit.
Hidden/removeable accessory tray (attaches to docking station) that may also serve as a stand for user's mobile phone.
The screen on device displays easy to follow visual, text, full color video and pictographic instructions on how to perform massage. Screen also display various device settings including, which body parts to massage, where to massage on the body parts, how to move the massage device, how long to massage certain body parts, the recommended and current power setting of the massage, and the current battery of the massage device, among others.
Audio capable of delivering audible user instructions through the integrated speaker or via a user's wireless headphones through the device's Bluetooth connection.
Docking station doubles as induction charger.
Docking station serves as a rechargeable/wireless mobile charging station and may be a carrying case.
Rubberized tinted/translucent coating over touch screen display that is color-matched with the rest of the device.
Automatic standby mode: after a set time of not being used, the massage device will enter its standby and off mode to conserve battery life.
Voice activation (e.g. “turn on,” “turn off,” “increase intensity,” “decrease intensity,” etc.).
Touch screen display.
Recessed trigger/power button.
Dimmable screen (manual and automatic).
Wi-Fi enabled to allow for the device to receive firmware updates and for the user to download new therapies.
USB-C charger.

In one embodiment, the massager and dock are sleek and attractive, which makes them more likely to be used as they can be set on top of a counter almost like a work of art or an ornament. The massager and extension handles may be light and is designed to be easy and comfortable to hold. The massager may be quiet and water resistant, so it can be used in wet areas and in situations, such as watching television.

In one embodiment, the massager may be precisely controlled, used on any body part, and with the right amount of pressure.

The form of the massager may attribute to its functionality. The massager may be lighter and easier to hold, but big enough to deliver the powerful relief needed. The massager may have a flexible grip. The extension handles may allow a user to reach the hard-to-reach places without needing assistance from another person. The screen allows users to receive instructions on device usage as well as receive information relating to device settings. The massager may be a portion of a system, and may have a dock or a docking station engagable with the massager.

Preferably, the massager will provide clear instructions, by sound, image, or text, but these instructions may be turned off to allow the user to learn and grow.

Other features and advantages inherent in the disclosed intelligent therapeutic device, besides those which are claimed and disclosed, will become apparent to those skilled in the art from the following detailed description and its accompanying drawings.

### BRIEF DESCRIPTION OF FIGURES

FIG. 1 is an illustration of the massager engaged with the dock, according to an example embodiment of a compact massager.

FIG. 2 is an illustration of the dock without the massager and shows the massage head hole and the mating indent that is configured to receive the massager and cradle it when not in use, according to an example embodiment of a compact massager.

FIG. 3 is an illustration of the dock showing the hidden massage head tray with three swappable massage heads, according to an example embodiment of a compact massager.

FIG. 4 is an illustration of the dock showing one embodiment of providing power to the dock/charger.

FIG. 5 is an illustration of three views of one embodiment of the massager showing the screen, the button, and the massage head engagement portion.

FIG. 6 is an illustration of several ways to grip and hold the massager, according to an example embodiment of a compact massager.

FIG. 7 is an illustration of the massager with an attachable extension handle, according to an example embodiment of a compact massager.

FIG. 8 is an illustration of the bottom of the massager about to be connected to an extension handle, according to an example embodiment of a compact massager.

FIG. 9 is an illustration of the sleek look of the extension handle connected to the massager, according to an example embodiment of a compact massager.

FIG. 10 is an illustration of the curved handle connected to the massager, which allows a user to reach hard to reach areas on their body without assistance from another person, according to an example embodiment of a compact massager.

FIG. 11 is an illustration of four different schemes and colors for the massager and dock, according to an example embodiment of a compact massager.

FIG. 12 is an illustration of three different designs for the curved extension handle, according to an example embodiment of a compact massager.

FIG. 13 is an illustration of two different schemes for the massager and dock, according to an example embodiment of a compact massager.

FIG. 14 is an illustration of a massager and dock with a strap that forms a carrying case, according to an example embodiment of a compact massager.

FIG. 15 is an illustration of the dock base/tray, which may store the massage heads/tips, according to an example embodiment of a compact massager.

FIG. 16 is an illustration of the back touchscreen on the massager, according to an example embodiment of a compact massager.

FIG. 17 is an illustration of a massager undocked, according to an example embodiment of a compact massager.

FIG. 18 shows the body scan mode, according to an example embodiment of a compact massager.

FIG. 19 is an illustration of two views of the massager with an extension handle, according to an example embodiment of a compact massager.

FIG. 20 is an illustration of a massager screen being wirelessly linked with a phone, according to an example embodiment of a compact massager.

FIG. 21 is an illustration of a phone app for the massager, according to an example embodiment of a compact massager.

FIG. 22 is an illustration of the massager and an associated phone app, according to an example embodiment of a compact massager.

FIG. 23 is an illustration of a screen display linked with a phone app for a home spa day, according to an example embodiment of a compact massager.

FIG. 24 is an illustration of a massager and phone with an accompanying app, according to an example embodiment of a compact massager.

FIG. 25 is an illustration of a phone, the massager, and the user, according to an example embodiment of a compact massager.

FIG. 26 shows one embodiment of a one-button control scheme, according to an example embodiment of a compact massager.

FIG. 27 is an illustration of two different schemes for another embodiment of the massager showing a display with user friendly information.

FIG. 28 is an illustration of four different schemes for another embodiment of the massager showing the body and the massage head engagement portion.

FIG. 29 is an illustration of four different schemes for another embodiment of the massager showing the body, the button, and the massage head engagement portion.

FIG. 30 is an illustration of four different schemes for another embodiment of the massager showing the body and the display with user friendly information.

FIG. 31 is an illustration of the massager engaged with the dock, according to an example embodiment of a compact massager.

FIG. 32 is an illustration of four different schemes for another embodiment of the massager showing the body, the button, and the massage head engagement portion.

FIG. 33 is an illustration of a perspective view of one embodiment of massager and dock.

FIG. 34 is an illustration of a first side view of one embodiment of massager and dock.

FIG. 35 is an illustration of a second side view of one embodiment of massager and dock.

FIG. 36 is an illustration of a top view of one embodiment of massager and dock.

FIG. 37 is an illustration of a bottom view of one embodiment of massager and dock.

FIG. 38 is an illustration of a front view of one embodiment of massager and dock.

FIG. 39 is an illustration of a rear view of one embodiment of massager and dock.

FIG. 40 is an illustration of a perspective view of one embodiment of massager.

FIG. 41 is an illustration of a first side view of one embodiment of massager.

FIG. 42 is an illustration of a second side view of one embodiment of massager.

FIG. 43 is an illustration of a front view of one embodiment of massager.

FIG. 44 is an illustration of a rear view of one embodiment of massager.

FIG. 45 is an illustration of a top view of one embodiment of massager.

FIG. 46 is an illustration of a bottom view of one embodiment of massager.

FIG. 47 is an illustration of a perspective view of one embodiment of massager extension handle.

FIG. 48 is an illustration of a first side view of one embodiment of massager extension handle.

FIG. 49 is an illustration of a second side view of one embodiment of massager extension handle.

FIG. 50 is an illustration of a top view of one embodiment of massager extension handle.

FIG. 51 is an illustration of a bottom view of one embodiment of massager extension handle.

FIG. 52 is an illustration of a front view of one embodiment of massager extension handle.

FIG. 53 is an illustration of a rear view of one embodiment of massager extension handle.

FIG. 54 is an illustration of a perspective view of one embodiment of massager extension handle.

FIG. 55 is an illustration of a first side view of one embodiment of massager extension handle.

FIG. 56 is an illustration of a second side view of one embodiment of massager extension handle.

FIG. 57 is an illustration of a font view of one embodiment of massager extension handle.

FIG. 58 is an illustration of a back view of one embodiment of massager extension handle.

FIG. 59 is an illustration of a top view of one embodiment of massager extension handle.

FIG. 60 is an illustration of a bottom view of one embodiment of massager extension handle.

FIG. 61A illustrates an exploded view of a massager and extension handle according to some embodiments of the disclosure.

FIG. 61B illustrates an exploded view of the massager viewed from another angle according to the same embodiment as shown in FIG. 61A without showing the extension handle.

FIGS. 62A and 62B are perspective views from different angles of a counterweight according to an example embodiment.

FIG. 62C are cross-sectional view of the counterweight according to the same embodiment as shown in FIGS. 62A and 62B.

FIGS. 63A and 63B are perspective views from different angles of a transmission crank according to an example embodiment.

FIG. 63C are cross-sectional view of the transmission crank according to the same embodiment as shown in FIGS. 62A and 62B.

FIG. 64 illustrates a cross-sectional view of a massager, according to some embodiments of the disclosure.

FIG. 65 illustrates a cross-sectional view of a massager according to some embodiments of the disclosure.

FIG. 66 illustrates an exploded view of one embodiment of a massager handle, according to an example embodiment of a massager.

FIG. 67 illustrates a massage head comprising a dome massage head, according to some embodiments of the disclosure.

FIG. 68 illustrates a massage head comprising a cone massage head, according to some embodiments of the disclosure.

FIG. 69 an embodiment of a massage head comprising a thumb massage head, according to some embodiments of the disclosure.

FIG. 70 illustrates a massage head comprising a wide double massage head, according to some embodiments of the disclosure.

FIG. 71 an embodiment of a massage head comprising a narrow offset double massage head, according to some embodiments of the disclosure.

FIG. 72 illustrates an exploded view of a massager dock according to some embodiments of the disclosure.

FIG. 73 illustrates a graphical user interface of a massager according to some embodiments of the disclosure.

FIG. 74 illustrates a graphical user interface of a massager according to some embodiments of the disclosure.

FIG. 75 illustrates a graphical user interface of a massager according to some embodiments of the disclosure.

FIG. 76 illustrates a graphical user interface of a massager according to some embodiments of the disclosure.

FIG. 77 illustrates a graphical user interface of a massager according to some embodiments of the disclosure.

FIG. 78 illustrates a graphical user interface of a massager according to some embodiments of the disclosure.

FIG. 79 illustrates a graphical user interface of a massager according to some embodiments of the disclosure.

FIG. 80 illustrates a graphical user interface of a massager according to some embodiments of the disclosure.

FIG. 81 illustrates a graphical user interface of a massager according to some embodiments of the disclosure.

FIG. 82 illustrates a graphical user interface of a massager according to some embodiments of the disclosure.

FIG. 83 illustrates a graphical user interface of a massager according to some embodiments of the disclosure.

FIG. 84 illustrates a graphical user interface of a massager according to some embodiments of the disclosure.

FIG. 85 illustrates a graphical user interface of a massager according to some embodiments of the disclosure.

FIG. 86 illustrates a graphical user interface of a massager according to some embodiments of the disclosure.

FIG. 87 illustrates a graphical user interface of a massager according to some embodiments of the disclosure.

FIG. 88 illustrates a graphical user interface of a massager according to some embodiments of the disclosure.

FIG. 89 illustrates a graphical user interface of a massager according to some embodiments of the disclosure.

FIG. 90 illustrates a graphical user interface of a massager according to some embodiments of the disclosure.

FIG. 91 illustrates a graphical user interface of a massager according to some embodiments of the disclosure.

FIG. 92 illustrates a graphical user interface of a massager according to some embodiments of the disclosure.

FIG. 93 illustrates a graphical user interface of a massager according to some embodiments of the disclosure.

### DETAILED DESCRIPTION OF THE ILLUSTRATIVE EMBODIMENTS

In the following detailed description, numerous specific details are set forth in order to provide a thorough understanding of various aspects of one or more embodiments. However, these embodiments may be practiced without some or all of these specific details. In other instances, well-known methods, procedures, and/or components have not been described in detail so as not to unnecessarily obscure aspects of embodiments.

While multiple embodiments are disclosed, still other embodiments will become apparent to those skilled in the art from the following detailed description. As will be realized, these embodiments are capable of modifications in various obvious aspects, all without departing from the spirit and scope of protection. Accordingly, figures and the detailed descriptions thereof are to be regarded as illustrative in nature and not restrictive. Also, the reference or non-reference to a particular embodiment shall not be interpreted to limit the scope of protection.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about,” may refer to a deviance of between 0.0001-10% from the indicated number or range of numbers.

As used herein and in the claims, the terms “comprising” (or any related form such as “comprise” and “comprises”), “including” (or any related forms such as “include” or “includes”), “containing” (or any related forms such as “contain” or “contains”), means including the following elements but not excluding others. It shall be understood that for every embodiment in which the term “comprising” (or any related form such as “comprise” and “comprises”), “including” (or any related forms such as “include” or “includes”), or “containing” (or any related forms such as “contain” or “contains”) is used, this disclosure/application also includes alternate embodiments where the term “comprising”, “including,” or “containing,” is replaced with “consisting essentially of” or “consisting of”. These alternate embodiments that use “consisting of” or “consisting essentially of” are understood to be narrower embodiments of the “comprising”, “including,” or “containing,” embodiments.

For the sake of clarity, “comprising”, including, and “containing”, and any related forms are open-ended terms which allows for additional elements or features beyond the named essential elements, whereas “consisting of” is a closed end term that is limited to the elements recited in the claim and excludes any element, step, or ingredient not specified in the claim.

As used herein and in the claims, “connect” or “attach” refer to direct or indirect physical joining one component to another, unless otherwise stated.

As used herein and in the claims, “operatively connect” refers to direct or indirect physical joining one component to another in such a way that they can work or interact together.

As used herein, the term “Z-shaped” refers to a shape with a first portion and a second portion that are substantially parallel to each other, and a slant intermediate portion that forms an angle between the first portion and the second portion. In some examples, the Z-shape may have rounded corners between the portions.

As used herein, the term “truncated circular” refers to a shape that the outer form of a cross section is comprised by segments of a circular, or ovoid parts, connected with straight parts. As an example, the connected portion between the straight parts and the circular or ovoid parts may have smooth angles.

It will be further understood that when an element is referred to as being “front”, “back”, “rear”, “top”, “bottom”, “left”, “right” or the like, these words are used to describe the relative position between the elements for convenience of description, and thus will not limit the example embodiments.

The present specification discloses an intelligent massage therapy device capable of receiving user inputs pertaining to the user's current health symptoms and massage therapy goals; intelligently assessing the user inputs to select an appropriate massage therapy script; and executing the selected script while providing real-time instructions and feedback to the user to maximize the massage script's effectiveness.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

As will be appreciated by one skilled in the art, the systems and methods may take the form of an entirely hardware embodiment, an entirely software embodiment, or an embodiment combining software and hardware embodiments. Furthermore, the systems and methods may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, compact discs, read-only-memory, optical storage devices, or magnetic storage devices.

Embodiments of the systems and methods are described below with reference to schematic diagrams, block diagrams, and flowchart illustrations of methods, systems, apparatuses and computer program products. It will be understood that each block of the block diagrams, schematic diagrams, and flowchart illustrations, and combinations of blocks in the block diagrams, schematic diagrams, and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

In the following description, certain terminology is used to describe certain features of one or more embodiments. For purposes of the specification, unless otherwise specified, the terms “massager”, “massage device”, “therapy device”, “massage therapy device”, “smart massage therapy device”, and “intelligent massage therapy device” generally refer to a device that provides physical therapy or relief, including, but not limited to, a portable massager, a handheld massaging device, an electrical stimulation device, an oscillation massage device, a percussion massager, a vibration massager, a pulse massager, a limb massaging device, and/or any combination thereof.

As used herein, the terms “script”, “therapy script”, or “therapeutic script”, generally refer to a series of programmable instructions which are interpreted and executed by the programmable therapeutic device.

As used herein, the term massage “therapy technique”, “physical therapy”, and “massage therapy techniques”, includes, but is not limited to, pulses, vibrations, percussions, oscillations, and electrical stimulations.

As used herein, the term “cylindrical” refers to a shape of a solid bounded by a closed generalized cylinder and two parallel planes. The planes may be circular or non-circular. As an example, the planes may be square with rounded corners.

In one exemplary embodiment, provided is a massager comprising: a power source; a motor; a counterweight cam; a transmission shaft; mechanism wherein the motor mechanism comprises a shaft that is lazy Z-shaped; a housing; one or more massage head attachment portions; and a display.

In some embodiments, the transmission shaft is lazy Z-shaped.

In some embodiments, the power source is a battery.

In some embodiments, the battery and the motor are on opposite ends of the massager.

In some embodiments, the massager further comprises one or more damping elements wherein the damping elements substantially reduce a noise level made by the massager when in use.

In some embodiments, the display is configured to display massage information to a user.

In some embodiments, the massage information consists of information selected from the group of information consisting of one or more of: a graphical depiction of a body; a graphical depiction of a body part; a body part indicator; a body part area indicator; a directional indicator; a proposed power indicator; an actual power indicator; a timer bar; instructions on how to use the massager; listing massage programs; selecting massage programs; massage program indicators; a battery indicator; and combinations thereof.

In some embodiments, the display is a touch screen display.

In some embodiments, the display is a light emitting diode display.

In some embodiments, the display is configured to automatically darken when not in use.

In some embodiments, the massager is provided with a recovery metric for a user and a plurality of user biometric data; wherein the massager is configured to use the recovery metric and the plurality of user biometric data to calculate a massage modulation that rapidly varies the massage frequency and amplitude during use.

In some embodiments, the massager is configured to play one or more massage therapy scrips.

In some embodiments, the massager further comprises one or more extension handles, wherein the one or more extension handles are configured to matingly and magnetically attach to an end of the massager.

In another exemplary embodiment, provided is a massager comprising: a rechargeable battery; a motor; a counterweight cam; a transmission shaft that is lazy Z-shaped; mechanism wherein the motor mechanism comprises a shaft that is lazy Z-shaped; a housing; a piston; an operations button; one or more damping elements; one or more massage head attachment portions; and a display; wherein the transmission shaft is lazy Z-shaped; wherein the battery and the motor are on opposite ends of the massager; and wherein the motor is operatively connected to the counterbalance cam, which is operatively connected to the transmission shaft, which is operatively connected to the piston, which is operatively connected to one of the one or more massage head attachment portions.

In some embodiments, the display is configured to display massage information to a user.

In some embodiments, the massage information consists of information selected from the group of information consisting of one or more of: a graphical depiction of a body; a graphical depiction of a body part; a body part indicator; a body part area indicator; a directional indicator; a proposed power indicator; an actual power indicator; a timer bar; instructions on how to use the massager; listing massage programs; selecting massage programs; massage program indicators; a battery indicator; and combinations thereof.

In some embodiments, the display is a touch screen display.

In some embodiments, the display is a light emitting diode display.

In some embodiments, the display is configured to automatically darken when not in use.

In some embodiments, the massager is provided with a recovery metric for a user and a plurality of user biometric data; wherein the massager is configured to use the recovery metric and the plurality of user biometric data to calculate a massage modulation that rapidly varies the massage frequency and amplitude during use.

In some embodiments, the massager is configured to play one or more massage therapy scrips.

In some embodiments, the massager further comprises one or more extension handles; wherein the one or more extension handles are configured to matingly and magnetically attach to an end of the massager.

In another exemplary embodiment, provided is a compact massager, comprising: (1) one or more massage head attachment portions; and (2) a massager body, having a top body end, and an opposing, bottom body end defining a length therebetween, and a front body side and a rear body side defining a cross-section therewithin, wherein the massager body is configured to connect with the one or more massage head attachment portions at the front body side, the massager body further comprises: (i) a motor, disposed proximate to the top body end; (ii) a PCBA, disposed proximate to the bottom body end; (iii) a display, disposed at the rear body side; (iv) a power source, disposed proximate to the bottom body end; wherein the power source is configured to electrically connect with the motor, the PCBA and the display; (v) a Z-shaped, transmission crank, configured to translate rotary motion from the motor to reciprocating motion of the one or more massage head attachment portions; and (vi) a counterweight, having an eccentric cam, an input shaft and an output shaft, wherein the input shaft is disposed at one side of the cam and is operatively connected to the motor, and an output shaft is disposed at an opposing side of the cam and is operatively connected to the transmission crank.

In some embodiments, the transmission crank further comprises a first annular portion, a second annular portion and a z-shaped crank shaft portion, the first annular portion is configured to operatively connect with the output shaft and has an inner annular diameter larger than an outer diameter of the output shaft, and the second annular portion is configured to connect with the one or more massage head attachment portions.

In some embodiments, the crank shaft portion further comprises a first linear portion, a second linear portion and a third linear portion, the first linear portion has an end that connects with the first annular portion and an opposing end that connects with the second linear portion at an angle of 70-105 degree, the third linear portion has an end that connects with the second linear portion and an opposing end that connects with the second annular portion, and the first linear portion and the third linear portion are parallel to each other.

In some embodiments, the cam is in a truncated circular shape and both the input shaft and the output shaft are disposed proximate to a truncated side of the cam.

In some embodiments, an axial axis of the output shaft is closer to the truncated side than that of the input shaft.

In some embodiments, the compact massager further comprises a housing for receiving the massager body, the housing has a substantially uniform overall cross-section along the length.

In some embodiments, the housing is formed by a front cover and a rear cover, the front cover and the rear cover are configured to connect together along the length.

In some embodiments, the front cover is configured to receive the one or more massage head attachment portions.

In some embodiments, the compact massager further comprises a frame having a top frame end, an opposing, bottom frame end, a front frame side and a rear frame side, wherein the frame is configured to receive the motor proximate to the top frame end at the front frame side, and to receive the power source proximate to the bottom frame end at the front frame side.

In some embodiments, the frame is further configured to receive the PCBA at the front frame side.

In some embodiments, the frame is further configured to receive the display at the rear frame side.

In some embodiments, the compact massager further comprises a motor rack connected with the frame and at least a bottom portion of the motor.

In some embodiments, the motor rack is fixedly connected with at least the bottom portion of the motor by a plurality of screws, and each of the screws is provided with a silicone ring.

In some embodiments, the motor rack further comprises a plurality of damping pads.

In some embodiments, the power source is a re-chargeable battery.

In some embodiments, the compact massager further comprises a piston operatively connected with the transmission crank and the one or more massage head attachment portions, the piston further comprises one or more damping sleeves, wherein the damping sleeves substantially reduce a noise level made by the massager when in use.

In some embodiments, the display is a touch screen display and/or a light emitting diode display.

In some embodiments, the display is configured to automatically darken when not in use.

In some embodiments, the massager is provided with a recovery metric for a user and a plurality of user biometric data, wherein the massager is configured to use the recovery metric and the plurality of user biometric data to calculate a massage modulation that rapidly varies the massage frequency and amplitude during use.

In some embodiments, the compact massager is configured to play one or more massage therapy scrips.

In some embodiments, the compact massager further comprises one or more extension handles; wherein the one or more extension handles are configured to matingly and optionally magnetically attach to the bottom body end.

In another exemplary embodiment, provided is a compact massager, having a top end and a bottom end defining a length therebetween, a front side and a rear side defining a cross-section therewithin, comprising: a rechargeable battery, disposed proximate to the bottom end; a motor, disposed proximate to the top end; a counterweight; a transmission crank that is Z-shaped; a housing having substantially overall cross-section for the massager body along the length; a piston; an operations button; one or more damping pads; one or more massage head attachment portions; and a display; wherein the battery is configured to electrically connect with the motor, the operations button and the display; and wherein the motor is operatively connected to the counterweight, which is operatively connected to the transmission crank, which is operatively connected to the piston, which is operatively connected to one of the one or more massage head attachment portions.

### LIST OF REFERENCE NUMERALS

1— Handle
2— Massager
21— Massager body
2101— Top body end
2102— Bottom body end
22— Massager head attachment portion(s)
3— Stand
105—Massager head front cover
110—Damping sleeve
115—Sliding sleeve
120—Piston
125—Piston fix
130— Massager front cover
135—Button
140—Damping pad
145—Main printed circuit board assembly (PCBA)
150—Battery
155—Massager Frame
160—Screws
165— Massager Bottom cover
170— Liquid Crystal Display (LCD) screen
180— Display touch panel
185— Massager rear cover
186— Display cover
190—Decorative plate
195—Pin
200—Transmission crank
201— First annular portion
202— Second annular portion
203— Crankshaft portion
2031— First linear portion
2032— Second linear portion
2033— Third linear portion
205— Counterweight
206— Output shaft
207— Input shaft
208— Cam
209— Truncated side
210—Silicone rings
215—Screws
220—Damping pad
225—Motor rack
230—Damping pad
235—Motor
240— Massager top cover
245—Extension handle covers
250—Magnet
255—Handle connector
260—Silicone pad
265—Sticker
500—Dock top cover
502— Top surface
503—Recess
505—Wireless charging transmitting coil
510— Dock interior housing and circuit board holder
515—Dock printed circuit board (PCB)
520—Massage head Silicone pad
525—Massage head rod
530—Massage head silicone cover
535—Massage head
540—Massage head
545—Massage head silicone cover
550—Massage head rod
560—Dock stand/Dock/Tray
565—Dock stand bottom cover

### Example 1

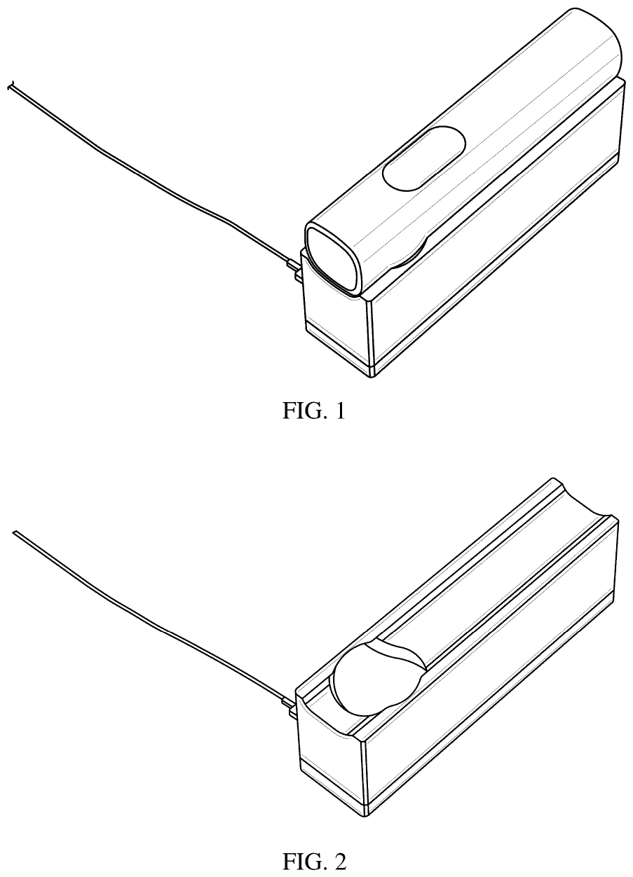

FIG. 1 is an illustration of the massager engaged with the dock.

Key features:
Small footprint designed to fit on home surfaces
Hidden and protected massage tip
Screen facing top for potential on dock interactions
   Preferably, undocking the device automatically turns it on and brings forward your most frequently used programs. Simply swipe or scroll through on the display screen (shown) and select with a simple tap or button press, without wasting any time setting up. The one button controls allow for a guided smart experience with intuitive control. In times where the device needs to be used right away, it may provide simple and intuitive feedback using the on-device screen, allowing users to get a more tailored and guided experience without the use of an app.

The massager may sense when a user is working or distracted. When a user lessens or removes pressure, the device pauses the program currently being following. This also allows a user to intuitively pause a program (by simply lifting the device) without missing a moment of your session. When the user re-applies pressure, the device will continue where it left off.

For quick use, the user may simply grab the massage device and press the front button once to turn it on when the device is undocked. Pressing the smart button without interacting with the back touch screen may put the device into manual mode, where the user can use the massage device as they would normally while being in full control. After being used to turn on the device, each additional button tap may increase the power through one of three (3) intensity levels.

Generally, the basic operation of the massager may be as follows:
Turning on & off
   As the user takes the Massage Gun out of the dock, it automatically turns ON.
   To turn on when not taking from the dock, simply press the button once to “Wake it up”.
   Hold the button for 10+ seconds to force the massage gun to turn off or simply return it to the dock.
   The massager may automatically turns off if on speed 0 and no activity has sensed for 30-60 seconds.
   Preferably, the device may treat the “sleeping” differently. For example, if a user is mid-program and leaves it off for less than an hour, the program could still live on the device as “active”. Whereas, if the user picks it up the next day or one or more hours later, it will simply be reset back to its original state (home screen).
Quick start program
   By pressing the button once, the user may jump straight into the ‘manual’ mode where they may circle/cycle through 4 speeds by a simple button press (Off-Low-Medium-High).
Selecting programs
   When the Massage Device is not in use, the user may simply swipe left/right (on the front touch screen) to navigate through the programs. Tapping the screen or pushing the button may select and stars the program/s shown on the screen.
Button interactions
   Single press may be, depending on the context
      Selecting program
      Changing speed
      Smart interaction with app (via Bluetooth or Wi-Fi)
   Button hold 3-5 seconds is the ‘BACK’ button that cancels out of programs or other activities that the user has loaded.
   Button hold for 8+ seconds forces the device to ‘TURN OFF’.
Screen interactions
   Bidirectional swiping and simple tap to select touch capabilities, mainly used for navigating and choosing programs. Navigation may happen BEFORE and AFTER a session, touch capabilities are locked during the session to prevent accidental inputs.
   Feedback/guidance can be shown during the session, and simple inputs may only happen between steps. For example, the display screen may provide instructions on which body part to massage, the specific area of the body part to massage, how to move the massage device, how long to use the massage device on a specific body part, the recommended and current power output of massage device, which massage head to use and the current battery and battery usage of massage device.

FIG. 2 is an illustration of the dock without the massager and shows the massage head hole and the mating indent that is configured to receive the massager and cradle it when not in use.

Key features:
Induction charging of the device
Unidirectional docking orientation

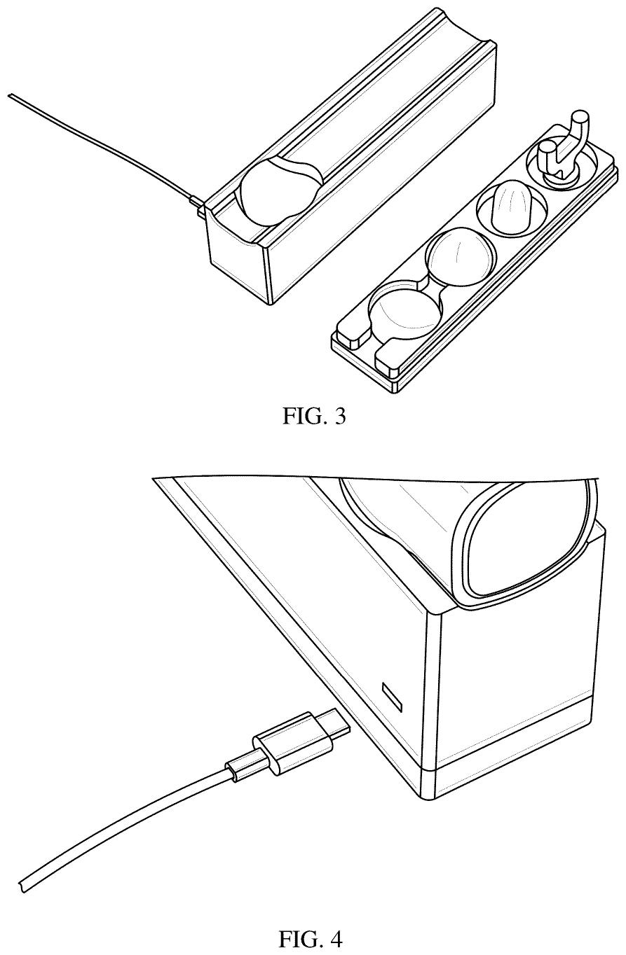

FIG. 3 is an illustration of the dock showing the hidden massage head tray with three swappable massage heads.
Key features: Accessory tray separated from the dock to move around with users and avoid having to go back to the dock

FIG. 4 is an illustration of the dock showing one embodiment of providing power to the dock/charger.
Key features: Dock connected via the same USB-C cable that can charge the device as well to make it easy to take it with you

FIG. 5 is an illustration of three views of one embodiment of the massager showing the screen, the button, and the massage head engagement portion.
Key features: Color matched, tinted display that feels inviting
Overmolded, recessed buttom
Universal usb-C connector

FIG. 6 is an illustration of several ways to grip and hold the massager.
Key features: Simple and flexible form factor allowing for many positions
More reach than

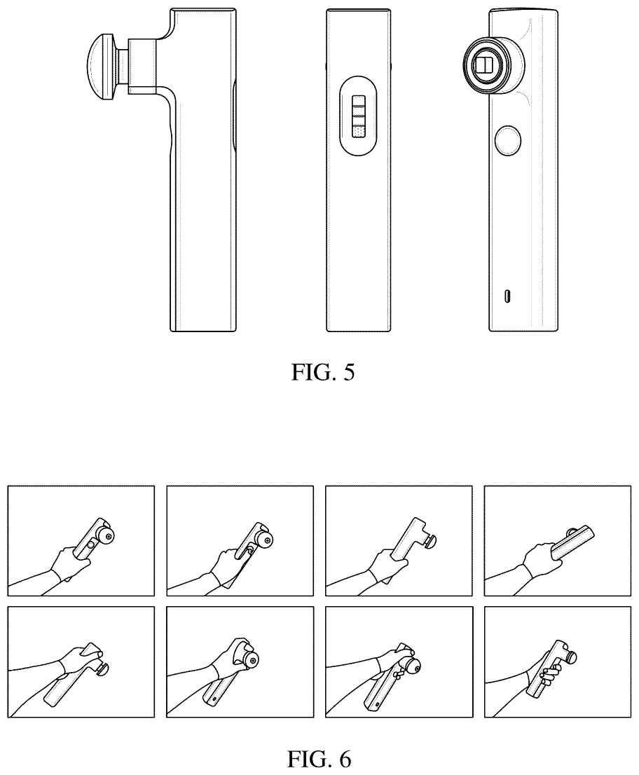

FIG. 7 is an illustration of the massager with an attachable extension handle.
Key features: Handle size identical to device form factor for easy carry and travel.

FIG. 8 is an illustration of the bottom of the massager about to be connected to an extension handle. Preferably, the connection is held firmly, but releasably, via one or more magnets.
Key features: Easy snap on magnetic connection

FIG. 9 is an illustration of the sleek look of the extension handle connected to the massager.
Key features: Shape continuity for flexible ergonomics

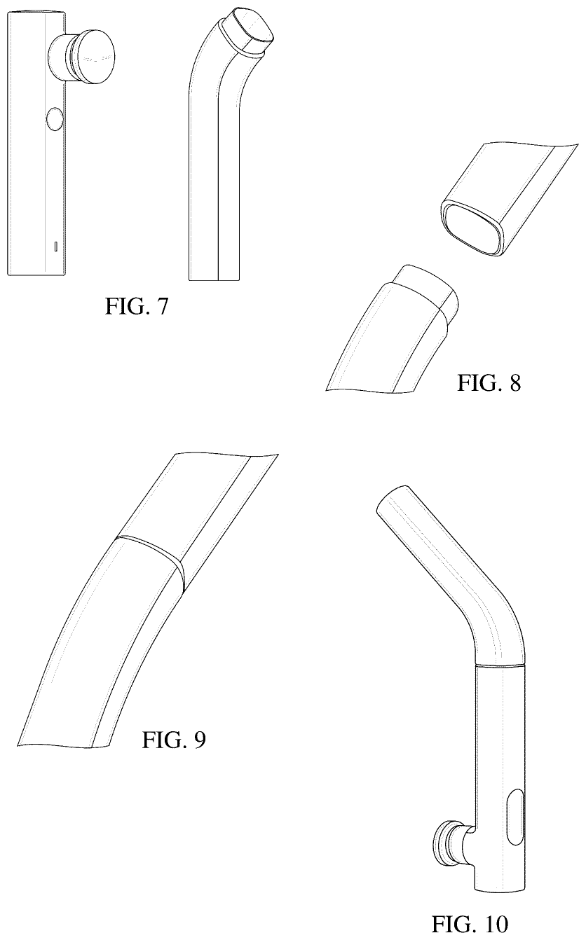

FIG. 10 is an illustration of the curved handle connected to the massager, which allows a user to reach hard to reach areas on their body without assistance from another person.
Key features: Angle designed to be able to extend reach comfortably

FIG. 11 is an illustration of four different schemes and colors for the massager and dock.

FIG. 12 is an illustration of three different designs for the curved extension handle.

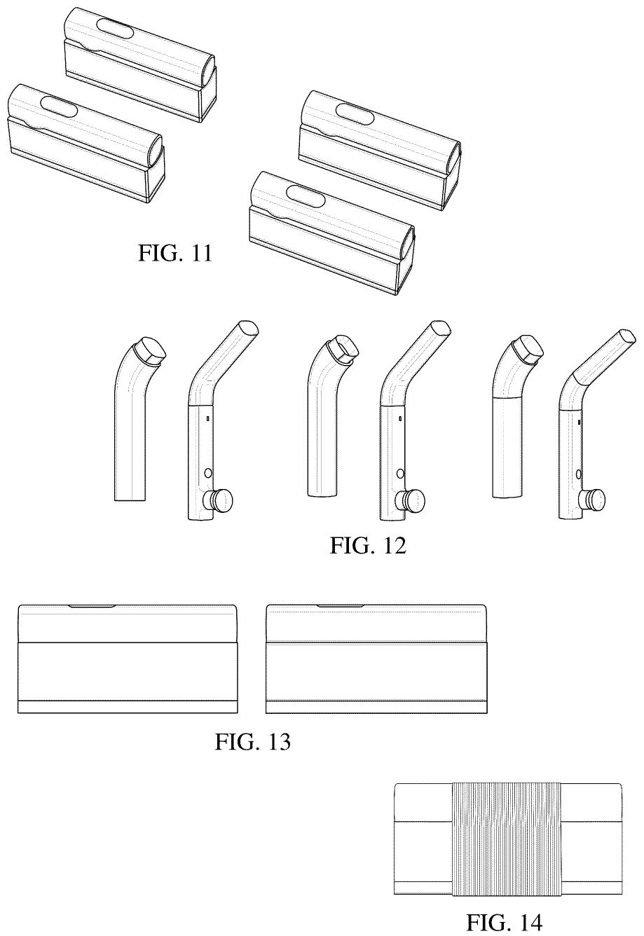

FIG. 13 is an illustration of two different schemes for the massager and dock.

FIG. 14 is an illustration of a massager and dock with a strap that forms a carrying case.
Key features: Dock can become a carrying case

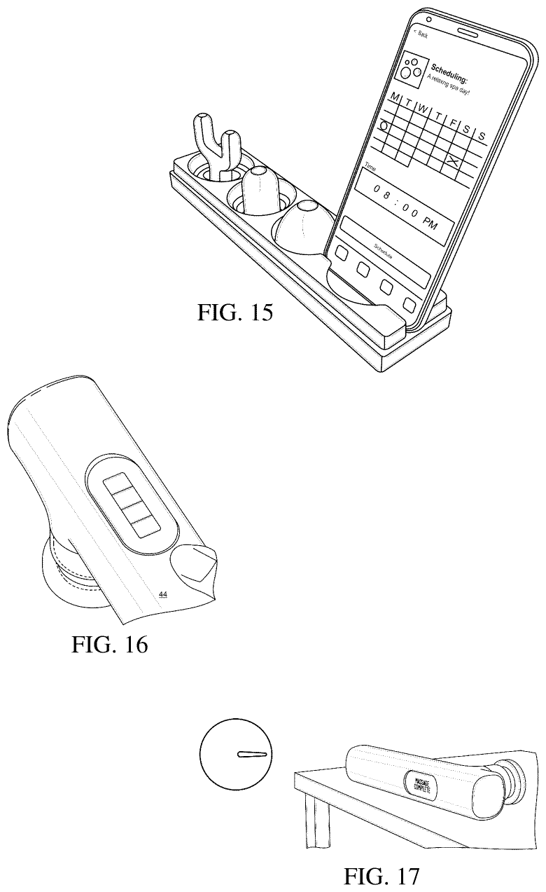

FIG. 15 is an illustration of the dock base/tray, which may store the massage heads/tips. It may also act as a stand and/or a plug in or induction charger for the user's smartphone.

FIG. 16 is an illustration of the back touchscreen on the massager. Using the on-device screen a user can adjust the intensity via touch and set it precisely as they prefer it.

FIG. 17 is an illustration of a massager undocked. The massager may automatically go on standby until it is needed. After a set time of not being used, the massage device may enter its standby & off mode. This helps conserve battery life for when it is needed the most.

FIG. 18 shows the body scan mode. In certain embodiments, the massager or massager system may include a body scan device configured to scan a body of a user for pain points. Built in assessment features may allow users to scan their body for pain points. Simple directions (sound and/or visual) tell the user where to put the massage device, while an automatic gradual intensity increase will allow setting a baseline for each spot with a press of a button. This helps the app know which intensity the user prefers at certain areas of his/her body, while also providing the app with an initial understanding of a user's pain points. This basic knowledge gathered manually can help tailor programs/scripts to be run by the user.

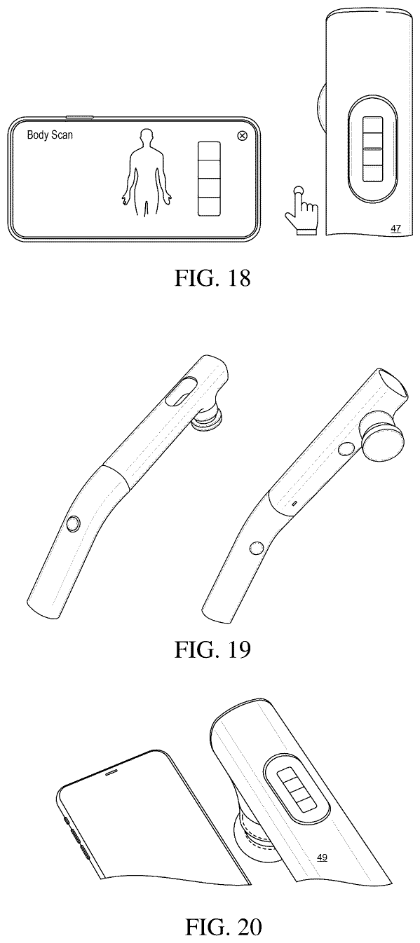

FIG. 19 is an illustration of two views of the massager with an extension handle. With more advanced accessories that move a user's hand away from the device interface (the button and the screen), preferably the extension handles may have control buttons or the user may use a phone app (touch or voice) to control the massager.

FIG. 20 is an illustration of a massager screen being wirelessly linked with a phone. With bluetooth, a phone could also be used as a remote control device. This could come in handy if the device has a long accessory attached, is held in place between pillows, or if someone else is massaging. No need to say, “harder!” or “softer please” anymore!. In certain embodiments, the massager further comprises a mobile wireless linking device to remotely control the massager via a mobile

The settings may be personalized. Syncing the phone to the massage device allows the user to unlock more advanced features and personalization. This has the added benefit of the massage device being able to recognize multiple people in a household without limiting the benefits of customization.

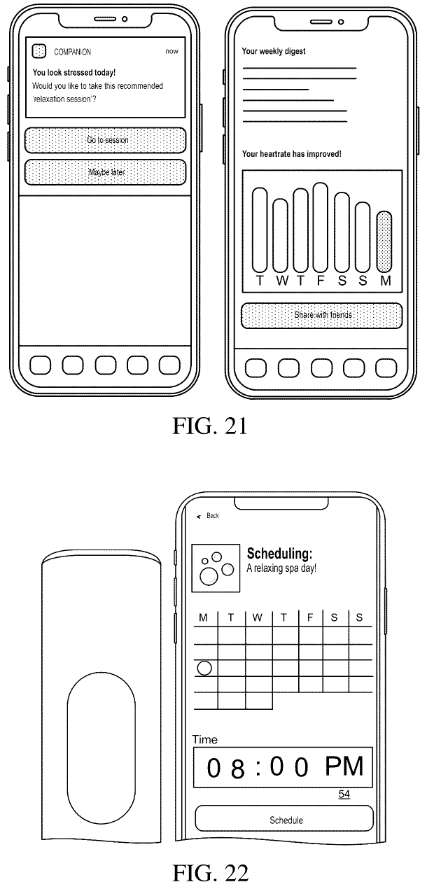

FIG. 21 is an illustration of a phone app for the massager. The app may gather and store data about the user and keep the user motivated and using the device. As the platform grows, there may be opportunities to further explore how data can be used to motivate users, while also tapping into existing health ecosystems, such as the heart rate monitors and fitness apps.

FIG. 22 is an illustration of the massager and an associated phone app. Moments of relaxation can be sacred times that require planning in advance to ensure that there is no distraction in the moment. Pre-planning a relaxation routine lets the app and device know that a user has plans to take some well-deserved “me” time.

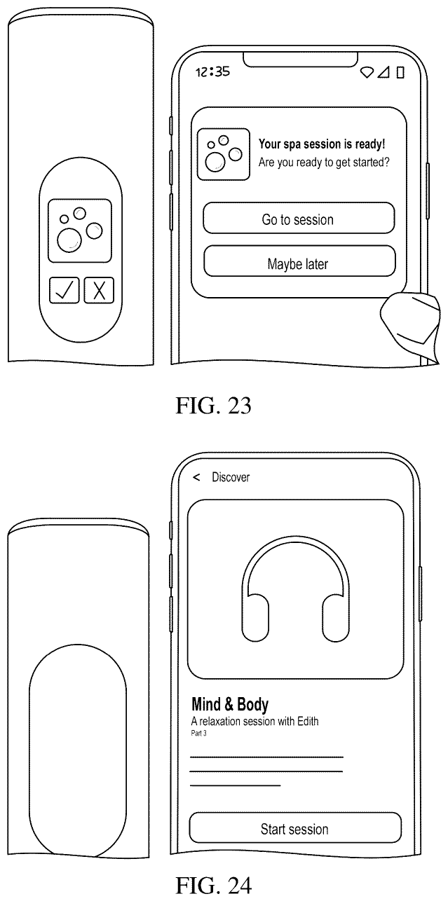

FIG. 23 is an illustration of a screen display linked with a phone app for a home spa day. A notification may be sent to the phone and the on-device screen at the scheduled time. Picking up the massage device at the pre-scheduled time means that the massage device already knows which program to load, so all user has to do is press play.

FIG. 24 is an illustration of a massager and phone with an accompanying app. The user may explore and upload programs. When the user has his/her next session in the app, they simply hit play, lean back and let the massage device sync and connect to the relaxation program. No need to use the on-device touch screen.

FIG. 25 is an illustration of a phone, the massager, and the user. Audio led experiences. Certain relaxation experiences call for deep immersion without distraction. Upon selecting an audio led experience, the massage device may dim its screen automatically, so the user can focus on the sounds around you without being distracted by the brightness of your screen. Perfect for winding down at night after a long day's work.

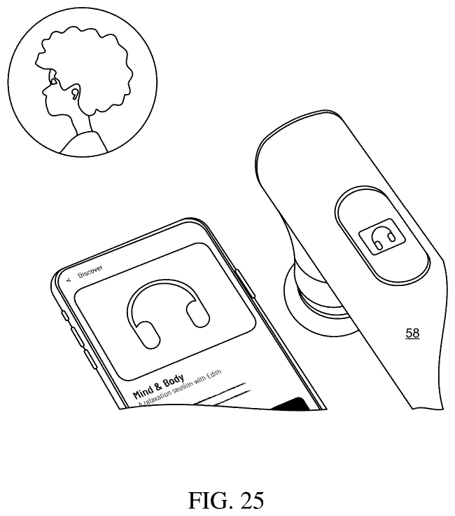

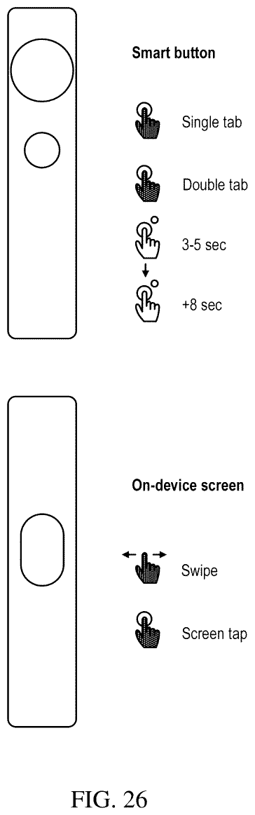

FIG. 26 shows one embodiment of a one-button control scheme.

TABLE 1
One-buttom control scheme of smart button and on-device screen

| | Turned off | Before & | During | During |
|---|---|---|---|---|
| Smart Button | (undocked) | After | (Regular Session) | (Smart Program) |
| Single tab | Turns on the | Selecting the | Change the | Program specific |
| | device | currently | intensity between | interaction |
| | | selected on- | 0 −> Low −> | E.g., Record pain |
| | | screen program | Medium −> High | points |
| | | | (loops & repeats) | |
| Double tab | No effect | No effect | No effect | Program specific |
| | | | | interaction |
| | | | | e.g.., Skip content |
| 3-5 sec | No effect | Resets the | Exits the current | Exits the current |
| | | program selector | program and enters | program and enters |
| | | to the home state | the home state | the home state |
| +8 sec | No effect | Turns off the | Turns off the | Turns off the |
| | | message device | message device | message device |
| On-device | Turned off | Before & | During | |
| screen | (undocked) | After | (All Sessions) | / |
| Swipe | No effect | Bidirectional | No effect. Screen is | / |
| | | navigation of | in display only | |
| | | pre-beded | mode | |
| | | programs | | |
| Screen tab | No effect | Selecting the | No effect. Screen is | / |
| | | currently | in display only | |
| | | selected on- | mode | |
| | | device program | | |

Note:
Undocking the device automatically turns it on & docking it will put it back into its standby mode where it will charge and sync with the cloud

FIG. 27 is an illustration of two different schemes for another embodiment of the massager showing a display with user friendly information. For example, the display may comprise a light emitting diode (LED) display and/or touch screen display, which is configured to show instructions relating to device usage. The display may show instructions for a user to use the massage device on a certain body part. For instance, the display may show an illustration of the body part. The display may show instructions for a specific area of the body part to massage. For instance, the display may show a start and end position for the body part to be massaged. The display may show instructions for a user to move the massage device in a certain way in order to properly target the body device area. For instance, the display may feature a beginning and end position for the massage. The display may show instructions for long to massage a body part. For instance, the display may have a timer bar and number indicating time remaining for the body part massage. The display may show a proposed power of the massage device. For instance, the display may show bars or other indicator of proposed power for a certain body part massage. The display may show a current power of the massage device. For instance, the display may show bars or other indicator to indicate current power of the massage device. The display may show a battery power for the massage device. For instance, the display may show a battery indicating the percentage or proportion of battery remaining in the massage device.

FIG. 28 is an illustration of four different schemes for another embodiment of the massager showing the body and the massage head engagement portion.

FIG. 29 is an illustration of four different schemes for another embodiment of the massager showing the body, the button, and the massage head engagement portion.

FIG. 30 is an illustration of four different schemes for another embodiment of the massager showing the body and the display with user friendly information.

FIG. 31 is an illustration of the massager engaged with the dock. Preferably, undocking the device automatically turns it on and brings forward your most frequently used programs. Simply swipe or scroll through on the display screen (shown) and select with a simple tap or button press, without wasting any time setting up. The one button controls allow for a guided smart experience with intuitive control. In times where the device needs to be used right away, it may provide simple and intuitive feedback using the on-device screen, allowing users to get a more tailored and guided experience without the use of an app.

FIG. 32 is an illustration of four different schemes for another embodiment of the massager showing the body, the button, and the massage head engagement portion.

### Example 2

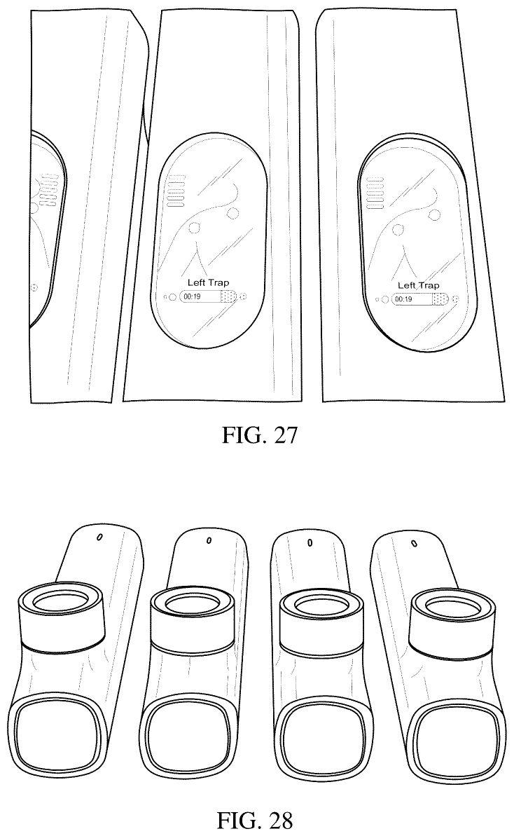

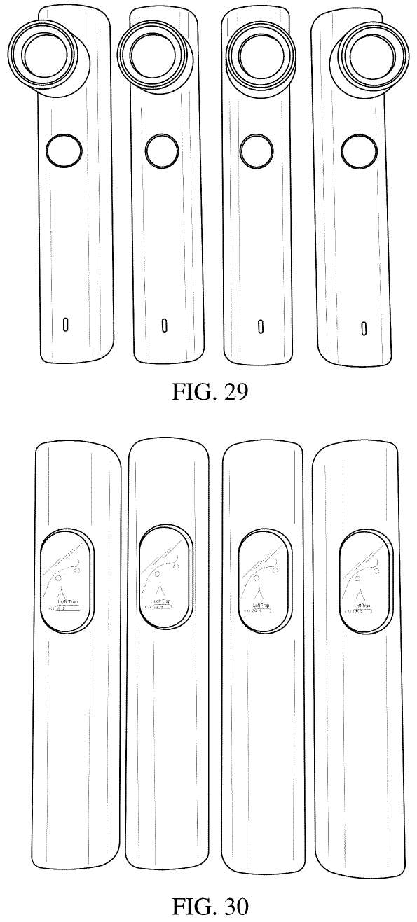

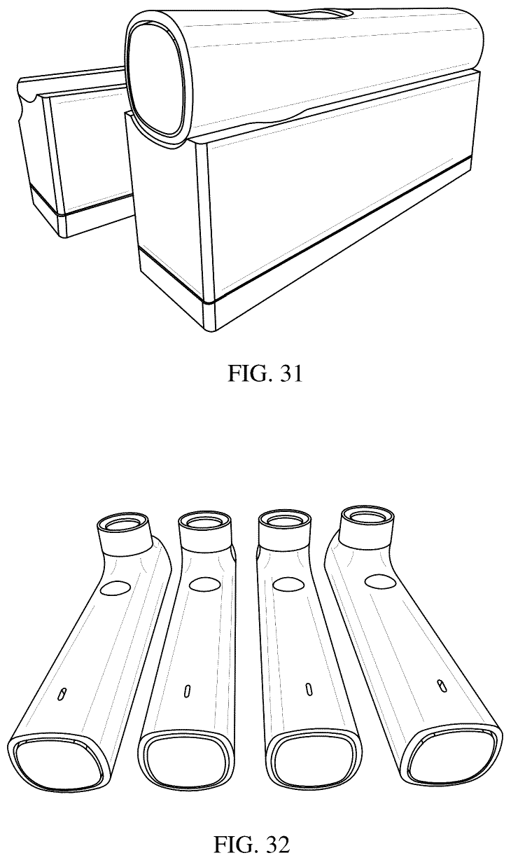

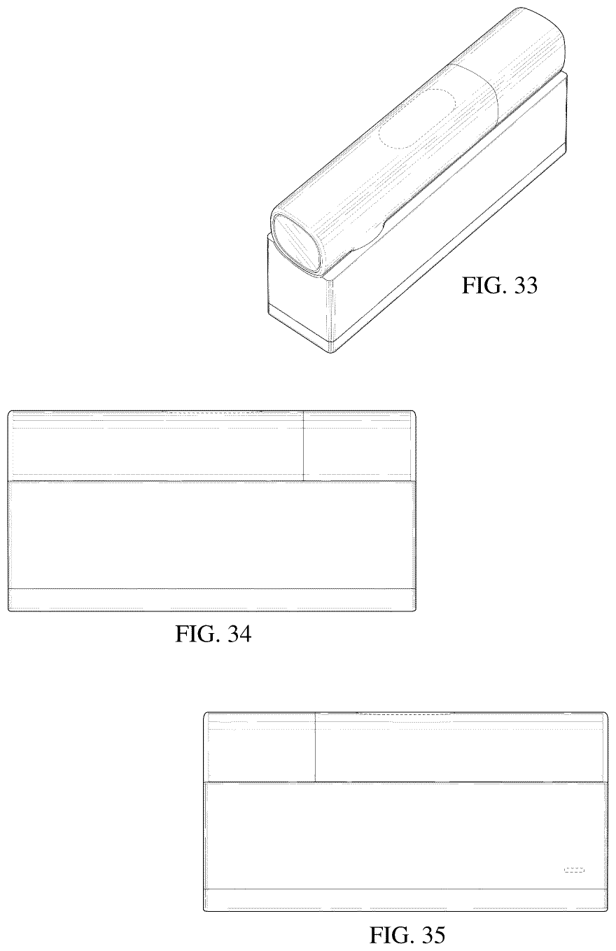

FIGS. 33-39 generally show one embodiment of a massager and a dock (or dock stand). The docking stand is configured to be engaged with the massager, and at least a part of the front side of the docking stand matches the size and shape of the front side of the housing of the massager, so that the docking stand hides and protects the attachment portion of the massage head when docking with the massager. The massage head is received in the recess.

FIG. 33 is an illustration of a perspective view of one embodiment of massager and dock.

FIG. 34 is an illustration of a first side view of one embodiment of massager and dock.

FIG. 35 is an illustration of a second side view of one embodiment of massager and dock.

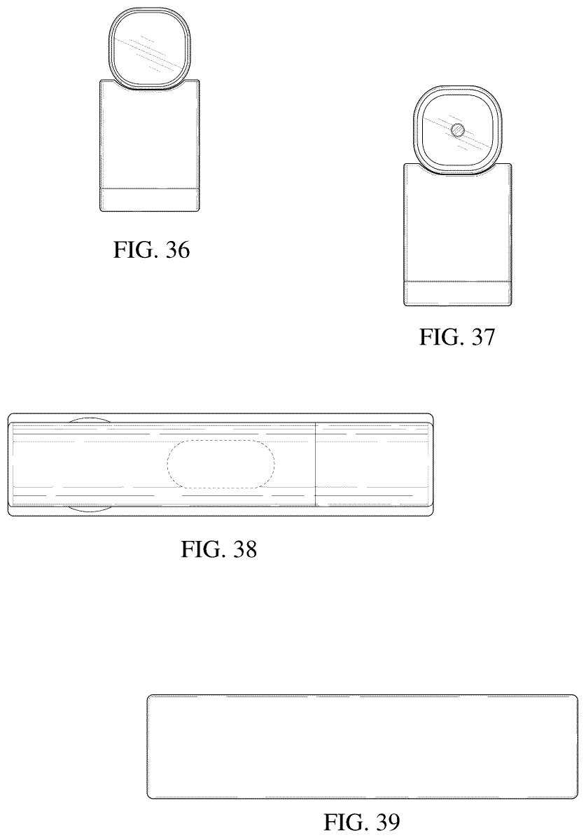

FIG. 36 is an illustration of a top view of one embodiment of massager and dock.

FIG. 37 is an illustration of a bottom view of one embodiment of massager and dock.

FIG. 38 is an illustration of a front view of one embodiment of massager and dock.

FIG. 39 is an illustration of a rear view of one embodiment of massager and dock.

FIGS. 40-44 generally show an example embodiment of a massager. In this example embodiment, the overall cross-sectional size of the massager body is basically the same, and the massager also includes a massage head attachment portion substantially perpendicularly extending from the massager body and a recessed trigger button.

FIG. 40 is an illustration of a perspective view of one embodiment of massager.

FIG. 41 is an illustration of a first side view of one embodiment of massager.

FIG. 42 is an illustration of a second side view of one embodiment of massager.

FIG. 43 is an illustration of a front view of one embodiment of massager.

FIG. 44 is an illustration of a rear view of one embodiment of massager.

FIG. 45 is an illustration of a top view of one embodiment of massager.

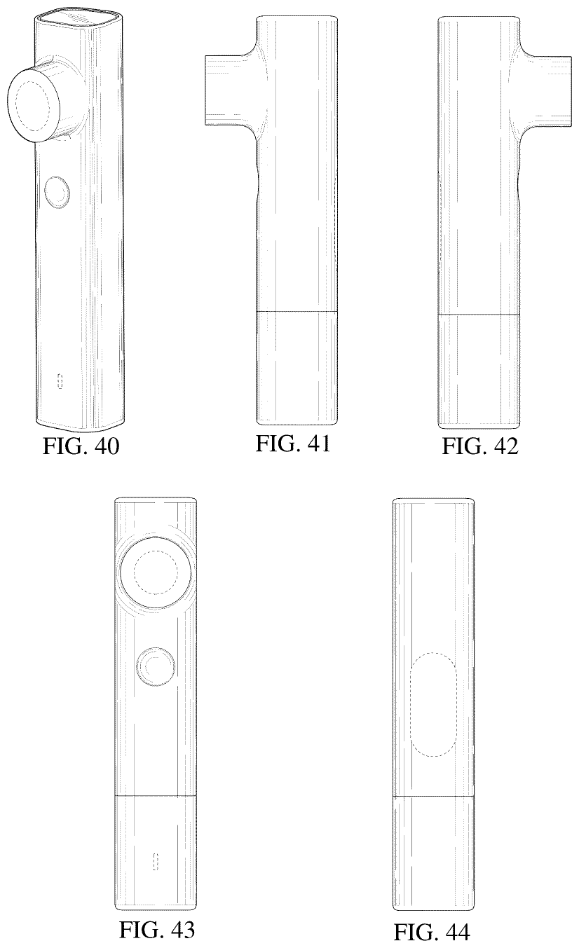

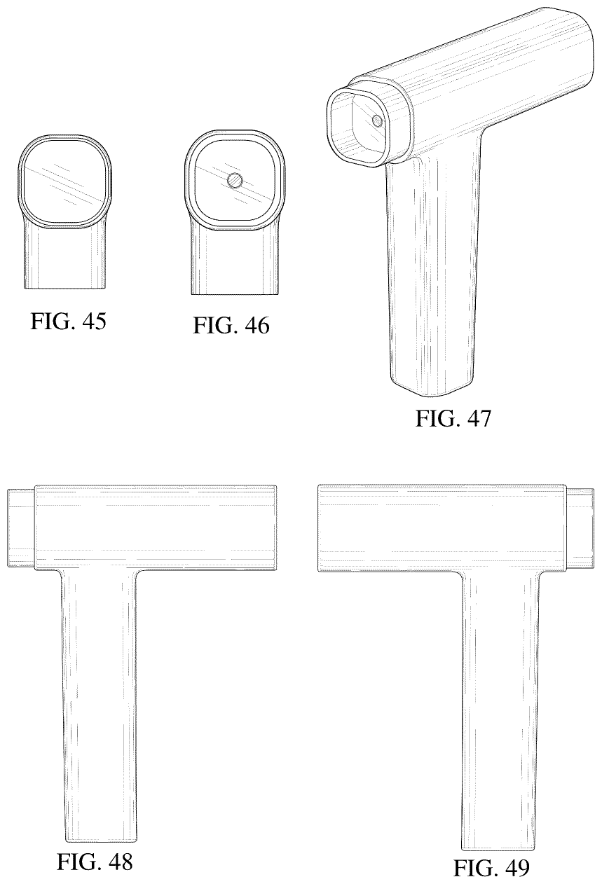

FIG. 46 is an illustration of a bottom view of one embodiment of massager.

FIGS. 47-53 generally show an example embodiment of a massager extension handle. In this example embodiment, the extension handle of the massager is substantially in a “T” shape, with a vertical extension portion and a horizontal extension portion which extends from one end of the vertical extension portion. The horizontal extension portion includes a longer end and a relatively shorter opposing end. The horizontal extension portion and the overall cross-sectional size and shape of the massager body are substantially the same.

FIG. 47 is an illustration of a perspective view of one embodiment of massager extension handle.

FIG. 48 is an illustration of a first side view of one embodiment of massager extension handle.

FIG. 49 is an illustration of a second side view of one embodiment of massager extension handle.

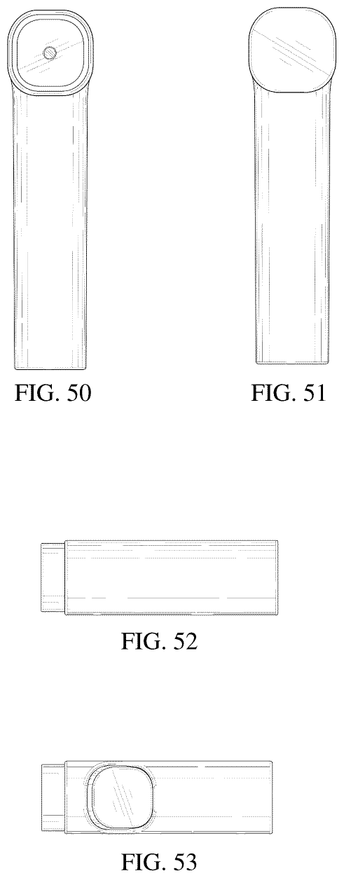

FIG. 50 is an illustration of a top view of one embodiment of massager extension handle.

FIG. 51 is an illustration of a bottom view of one embodiment of massager extension handle.

FIG. 52 is an illustration of a front view of one embodiment of massager extension handle.

FIG. 53 is an illustration of a rear view of one embodiment of massager extension handle.

FIGS. 54-60 show another example embodiment of a massager extension handle. In this example embodiment, the massager extension handle is substantially in a “semi-U” shape as a whole, with a vertical extension portion and a curved portion which extends from one end of the vertical extension portion. The curved portion has a magnetic connecting portion, and is configured to be matched with the housing. At least the connecting portion of the curved part is substantially the same as the overall cross-sectional size and shape of the massager body.

FIG. 54 is an illustration of a perspective view of one embodiment of massager extension handle.

FIG. 55 is an illustration of a first side view of one embodiment of massager extension handle.

FIG. 56 is an illustration of a second side view of one embodiment of massager extension handle.

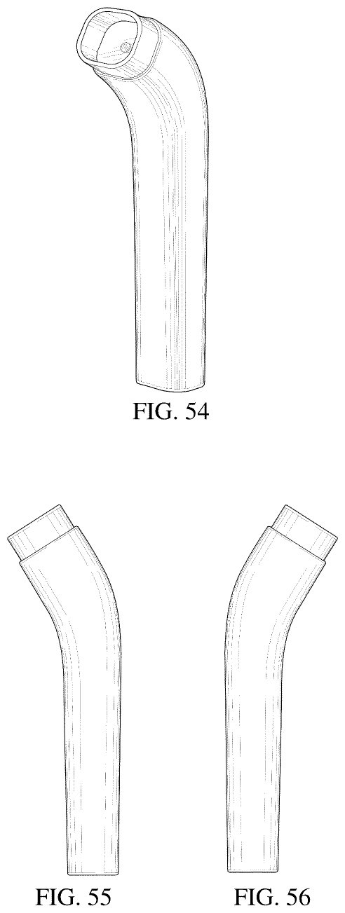

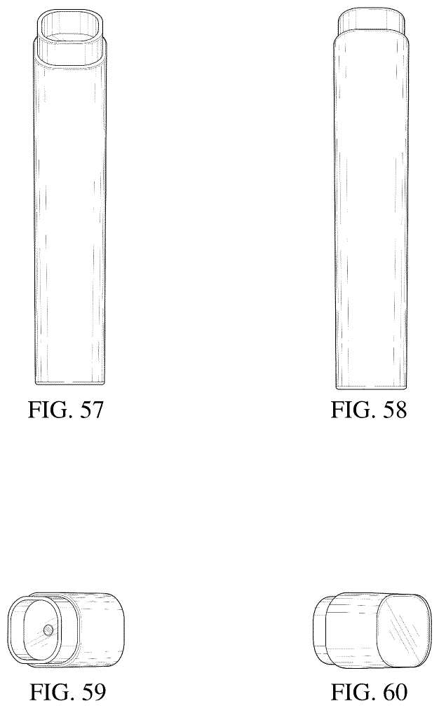

FIG. 57 is an illustration of a font view of one embodiment of massager extension handle.

FIG. 58 is an illustration of a back view of one embodiment of massager extension handle.

FIG. 59 is an illustration of a top view of one embodiment of massager extension handle.

FIG. 60 is an illustration of a bottom view of one embodiment of massager extension handle.

### Example 3

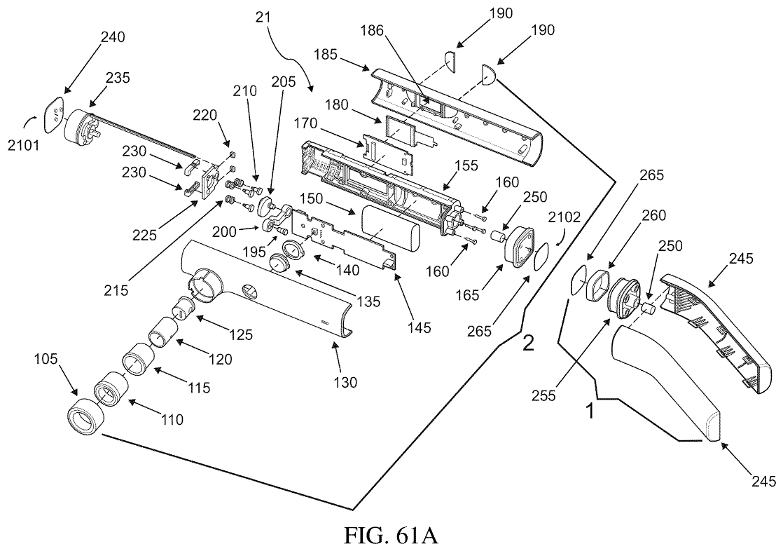

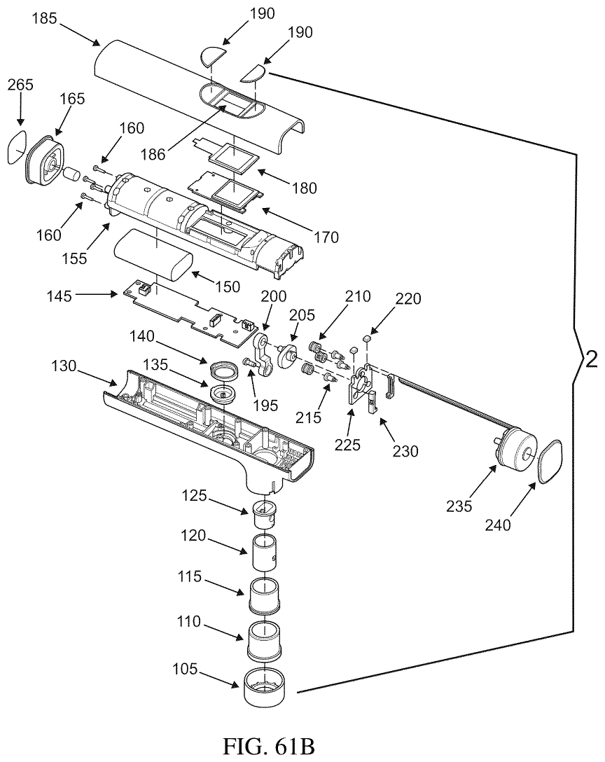

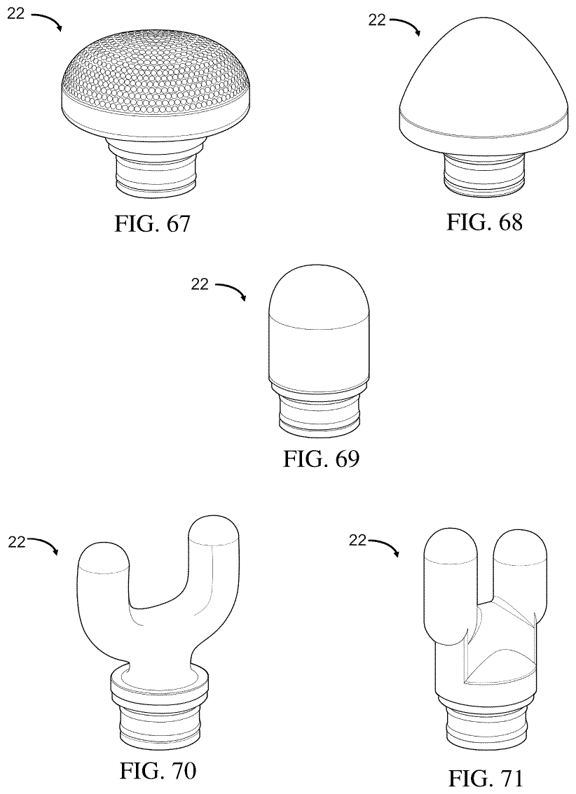

FIGS. 61A and 61B illustrates an exploded view of a massager with and without an extension handle, respectively, according to some embodiments of the disclosure. As shown in FIG. 61A, the massager 2 generally comprises a massager body 21 and a massager head attachment portion 22 (also shown in FIGS. 67-71). As an example, the massager 2 may have a plurality of massager head attachment portions 22. The massager body 21 has a top body end 2101, and an opposing, bottom body end 2102 defining a length therebetween, and a front body side and a rear body side defining a cross-section therewithin. In this embodiment, the massager 2 further comprises a massager front cover 130 and a massager rear cover 185. The massager front cover 130 and the massager rear cover 185 are connected together along the length to form a massager housing for receiving the massager body 21. For ease of description, the direction towards the massager front cover 130 is called “front”, the direction towards the massager rear cover 185 is called “rear”, the direction towards the top body end 2101 is called “top”, and the direction towards the bottom body end 2102 is called “bottom”. The massager body 21 is configured to connect with the one or more massage head attachment portions at the front body side. The massager head attachment portion 22 may comprise massager head front cover 105, damping sleeve 110, sliding sleeve 115, piston 120, and piston fix 125. The massager head front cover 105 is sized and shaped to fit the outer circumference of the annular opening of the front cover 130. Piston fix 125, piston 120, sliding sleeve 115 and one or more of damping sleeves 110 are all sized and shaped to be received from and operatively connected with one another sequentially. The damping sleeves substantially reduce a noise level made by the massager when in use. The piston fix 125 includes a first hole adapted to receive a pin 195 such as to operatively connect with the transmission crank 200, thereby translating a rotary motion from the motor via the transmission crank 200 to reciprocating motion of the piston and subsequently the massage heads (not shown here, but will be described in details later) attached thereto.

The massager body may comprise massager front cover 130, button 135, damping pad 140, main printed circuit board assembly (PCBA) 145, battery 150, massager frame 155, one or more screws 160, massager bottom cover 165, liquid crystal display (LCD) screen 170, touch panel 180, massager rear cover 185, display cover 186, one or more decorative plates 190, pin 195, transmission shaft 200, counterweight cam 205, one or more silicone rings 210, one or more screws 215, one or more damping pads 220, motor rack 225, one or more damping pads 230, motor 235, massager top cover 240, and magnet 250. The massager front cover 130 and the massager rear cover 185 are connected together along the length to form a massager housing. The overall cross-section of the massager body 21 along the massager length is substantially the same (disregarding the annular opening for massage head attachment portion to extend through). In this example embodiment, the massager rear cover 185 does not have any extension protruding outwardly from the rear of the massager rear cover 185. In this example, battery 150 is the power source of the massager 2 and may be re-chargeable by a docking stand (not shown), and is configured to electrically connect with the motor 235, the PCBA 145 and LCD screen as a display and touch panel 180. The massager frame 155 is specially sized and shaped to receive and support various components of the massager 2. Frame 155 generally has a semi-cylindrical, hollow shape with various grooves or receiving portions and has a top frame end, an opposing, bottom frame end, a front frame side and a rear frame side. The frame 155 is sized and shaped to receive and fix motor rack 225 by three screws 210, together forming a space to fit for the motor, so that the motor may be positioned proximate to the top frame end at the front frame side. Each of the screws 210 are provided with a silicone ring 210 to absorb vibration. The motor rack 225 may also include a pair of damping pads sized and shaped to cover at least two opposing vertical sides of rack 225 to further absorb the vibration. The frame 155 is also sized and shaped to receive the battery (power source) proximate to the bottom frame end at the front frame side, and also sized and shaped to receive the battery 150 proximate to the bottom frame end at the front frame side. The frame 155 is further sized and shaped to receive the PCBA at the front frame side, together sandwiching the battery 150 within the formed chamber. The back frame side of the frame 155 may also sized and shaped to fit to be received in the inner side of the massager rear cover 185 to form an area to receive and sandwich the LCD screen 170 and touch panel 180 therewithin. As an example, the LCD screen may be a full-color screen and may display videos to users. The housing and the frame 155 together form a strong support for the components to position and/or move within designated zones.

The massager 2 may further include a handle 1, which includes extension handle covers (or extension handle housings) 245, magnet 250, handle connector 255, silicone pad 260, and sticker 265.

FIG. 61B illustrates an exploded view of a massager with no extension handle according to some embodiments of the disclosure. As shown in FIG. 61B the massager 2 may damping sleeve 110, damping pad 140, one or more silicone rings 210, one or more damping pads 220, and one or more damping pads 230, all of which provide significant sound damping effects that reduce the noise that massager 2 makes when in use. Collectively, the damping parts are referred to as the damping elements. FIG. 61B shows how the piston fix 125 is configured to engage with and connect piston 120 to shaft 200, such that when the motor turns, the piston is driven back and forth in a percussion manner.

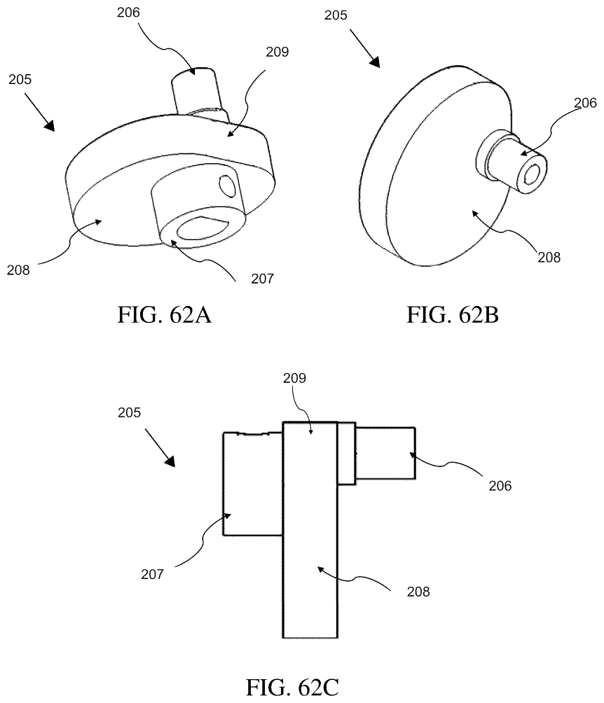

Now referring to FIGS. 61A, 61B, 62A, 62B and 62C together, the massager 2 may comprise a counterweight 205. The counterweight 205 may have an eccentric cam 208 which is substantially truncated circular shaped, and an input shaft 207 and an output shaft 206, both of which are formed from or fixedly connected to the cam 208. The input shaft 207 may be disposed at one side of the cam and sized and shaped to fit with the output end of the motor 235, and an output shaft 206 may be disposed at an opposing side of the cam 208 and operatively connected to the transmission crank 200. Both the input shaft 207 and the output shaft 206 may be disposed close to a truncated side 209 of the cam 208, away from the center of the cam 208. As an example, the axial axis of the output shaft 206 may be closer to the truncated side 209 than that of the input shaft 207, i.e., the output shaft 206 has a larger travel distance than that of the input shaft 207. These specific arrangements in axial axis and shape of the counterweight 205 can enhance the overall travel distance of the percussion tip of the massage head can be enhanced to allow “deep” massage, despite the smaller size (compact design) of the massager. As an example, the travel distance may be 8-10 mm. The counterweight 205 may be adapted to connect to transmission crank 200. The counterweight 205 may be adapted to balance the motor shaft connected to motor 235. The counterweight 205 may be adapted to drive the piston 120, in a balanced manner, and, thus, drive any massage attachment, such that there is no imbalance on the motor shaft connected to motor 235. As a result of counterweight 205 correcting any possible imbalance, there is a substantial reduction in the vibration and noise in the massager 2. In some embodiments, counterweight 205 may be custom made from metals such as zinc or a similar metal.

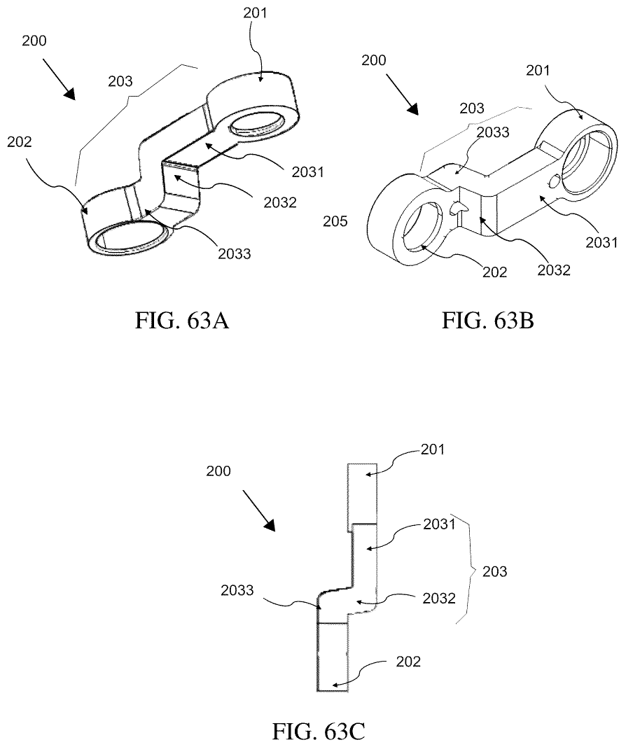

Now referring to FIGS. 61A, 61B, 63A, 63B and 63C together, the massager 2 may also comprise transmission crank 200. The transmission crank 200 may further include a first annular portion 201, a second annular portion 202 and a z-shaped crankshaft portion 203. The first annular portion 201 is configured to operatively connect with the output shaft 206 (shown in FIG. 62A-62C) and has an inner annular diameter larger than outer diameter of the output shaft 206. The second annular portion 202 is configured to operatively connect with piston fix 125 of one or more massage head attachment portions via pin 195. The crankshaft portion 203 further comprises a first linear portion 2031, a second linear portion 2032 and a third linear portion 2033. The first linear portion 2031 has an end that may connect with the first annular portion 201 and an opposing end that may connect with the second linear portion 2032 at an angle, for example, of 70-105 degrees, the third linear portion 2033 has an end that may connect with the second linear portion 2032 and an opposing end that may connect with the second annular portion 202, and the first linear portion 2031 and the third linear portion 2033 may be substantially parallel to each other. As an example, the angle may be 102 degrees. In some embodiments, the first linear portion 2031 may be longer than the third linear portion 2033. Transmission crank 200 may be configured into a substantially Z-shape instead of a simple flat bar. The Z-shape of transmission crank 200 allows transmission crank 200 to fit into the small spaces between massager front cover 130 and massager frame 155. The Z shape of transmission crank 200 also reducing the potential for the entire motor mechanism binding and allows the transmission crank 200 to fit neatly into the very compact internal geometry of the massager. Additionally, the Z-shaped transmission crank also allows for a shorter neck of the massager.

In some embodiments, transmission crank 200 may comprise smooth angle transitions such as fillets on the internal corners of transmission crank 200 in order to allow transmission crank 200 to withstand forces from intense massages. In some embodiments transmission crank 200 may be comprised of a sufficiently durable material in order to withstand forces from intense massages.

As shown in FIG. 61A (and also FIG. 33 from Example 2), the size and internal layout of the massager is relatively small. As an example, the massager may have a length of around 20-25 cm and the body may have a cross section in rounded square with a longest width of around 4-5 cm. In one example embodiment, the length of the massager is up to around 22 cm and the longest width is up to around 4.5 cm. Because the lower portion of the massager contains heavy electronics including main PCBA 145 and battery 150, the motor 235 may be located in a very small area in the top quarter of the massager. This counterweight system balances out the massager 2 and significantly reduces stress on the user's hands during operation. The diameter of motor 235 may be very similar to the internal shell diameter of the massager such that motor 235 may be mounted so as to not increase overall diameter. Motor 235, therefore, may be mounted on massager top cover 240 through specific mounting points comprising rubber or silicone washers. In some embodiments, the mounting points and rubber washers attached to massager top cover 240 may further reduce vibrations caused from the motor so that an associated user will feel less vibrations in their hand while holding the massager.

As shown in FIG. 61A, piston 120 may be adapted to neatly slide into and between sliding sleeve 115 and piston fix 125 such that the tight fit (and damping sleeve 110) causes a significant noise reduction in the massager.

As shown in FIG. 61A, massager 2 together with the handle preferably comprises two magnets 250. One of these magnets 250 may be located in the body of massager next to massager bottom cover 165. The other magnet 250 may be located in the handle of massager next to silicone pad 260. Magnets 250 and abutting parts massager bottom cover 165 and silicone pad 260 may be adapted such that magnets 250 matingly connect and allow a stable connection between the massager and massager handle. In some embodiments, there may be an overlapping flange between massager bottom cover 165 and silicone pad 260 adapted to prevent twisting.

In some embodiments, LCD screen 170 may be adapted to automatically darken. For example, in some embodiments, after a certain duration of time without use, LCD screen 170 may auto darken. In some embodiments, LCD screen 170 may be configured to auto-darken in response to environmental stimuli. In some embodiments, LCD screen 170 may be configured to auto-darked due to other criteria, such as non-use for a set period of time.

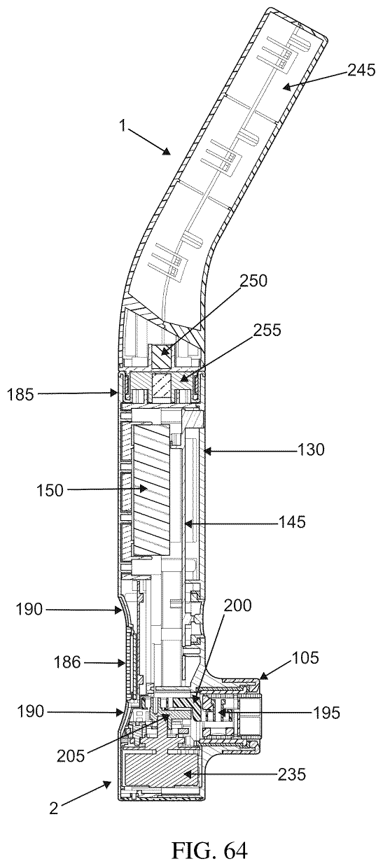

FIG. 64 illustrates a cross-sectional view of a massager according to some embodiments of the disclosure. As shown in FIG. 64 the massager may comprise massager head front cover 105, massager front cover 130, main PCBA 145, battery 150, touch panel 180, massager rear cover 185, one or more decorative plates 190, transmission shaft 200, counterweight cam 205, motor 235, extension handle 245, one or more magnets 250, and handle connector 255. As shown in FIG. 64, the motor 235 is configured to connect to counterweight cam 205, which itself is connected to the shaft 200. As such, when the motor 235 is on, the counterweight cam 205 rotates, which causes the shaft 200 to piston back and forth.

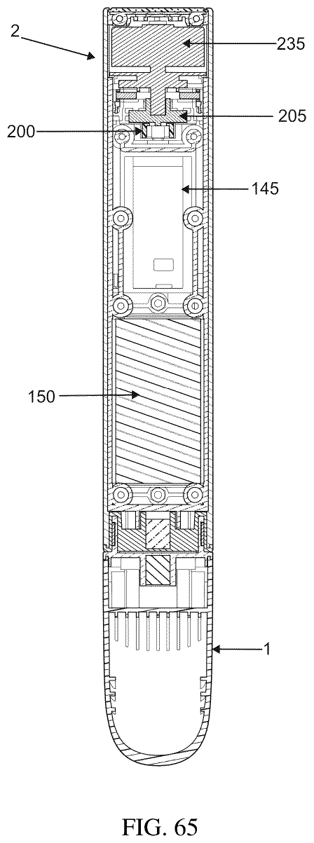

FIG. 65 illustrates a cross-sectional view of a massager according to some embodiments of the disclosure. As shown in FIG. 65, the massager 2 may comprise PCBA 145, battery 150, counterweight cam 205, transmission shaft 200, and motor 235.

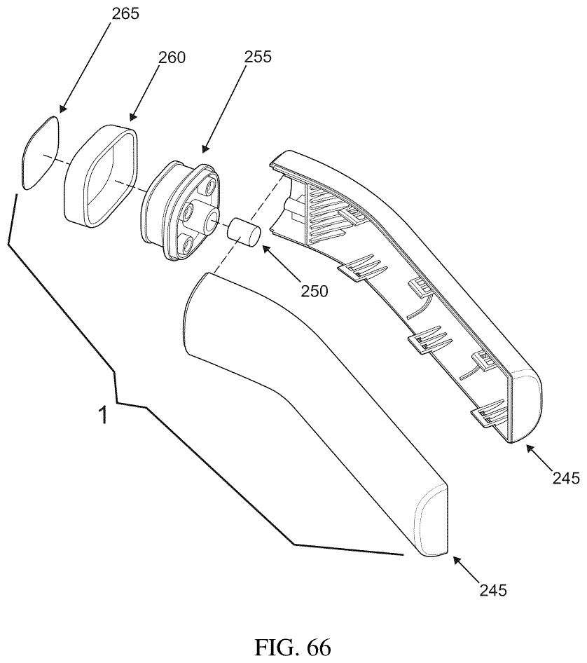

FIG. 66 illustrates an exploded view of one embodiment of a massager handle 1. As shown in FIG. 62, the massager handle may comprise extension handle covers 245, one or more magnets 250, handle connector 255, silicone pad 260 and sticker 265.

As shown in FIG. 66, in some embodiments, massager extension handle may comprise a rounded-square design, which allows for there to be four gripping positions and be comfortable held in all four.

FIG. 67 illustrates a massage head comprising a dome massage head according to some embodiments of the disclosure. In this example, the massage head is generally dome-shaped, with annually and continuously arranged, multiple arrays of circular dents on the surface,

FIG. 68 illustrates a massage head comprising a cone massage head according to some embodiments of the disclosure. In this example, the massage head is in cone shape with a rounded tip.

FIG. 69 an embodiment of a massage head comprising a thumb massage head according to some embodiments of the disclosure.

FIG. 70 illustrates a massage head comprising a wide double massage head according to some embodiments of the disclosure. In this example, the massage head is generally in a U-shape.

FIG. 71 an embodiment of a massage head comprising a narrow offset double massage head according to some embodiments of the disclosure.

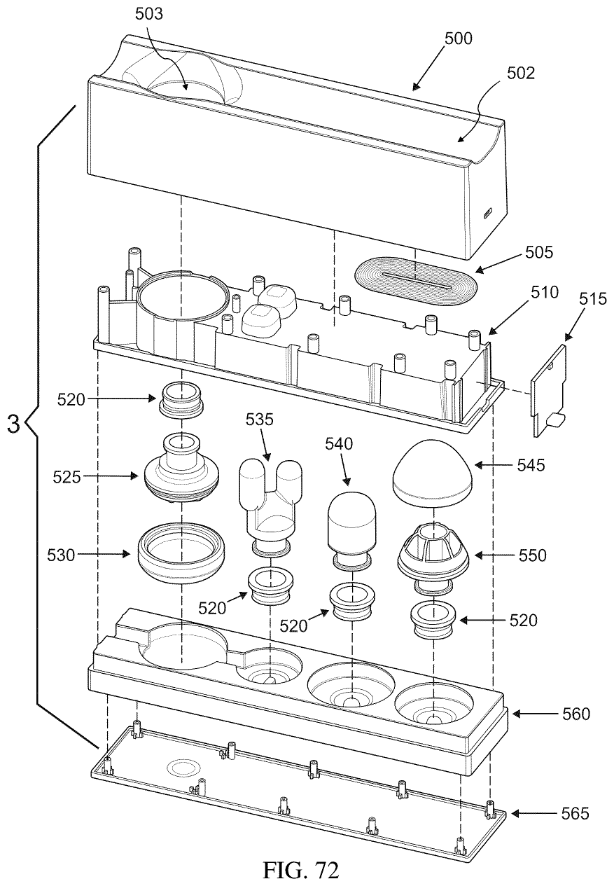

FIG. 72 illustrates an exploded view of a massager dock (or docking stand) 3 according to some embodiments of the disclosure. As shown in FIG. 72, the massager dock 3 may comprise a dock top cover 500, wireless charging transmission coil 505, dock printed circuit board (PCB) 515, PCB cover 510, dock stand (or tray) 560, and dock stand bottom cover 565. The docking stand 3 is sized and shaped to be engaged with a massager described herein, and has a concave top surface 502 and a recess 503 such as to receive the front side of the housing of the massager. The docking stand may hide and protect the massage head attachment portion and/or the massage head attached thereto via the recess when the massager docks with the docking stand. The massage head and/or the massage head attachment portions is received in the recess. The tray 560 includes 4 circular massage head receiving portions in various dimensions to receive the massage heads and further includes a slot sized and shaped to receive a mobile phone.

One or more massage heads may be provided for use with the massager and the docking stand. The massager heads may have various sizes and shapes and may include one or more massage head silicone pads 520, one or more massage head silicone covers 530 and 545, one or more massage head rods 525 and 550, and one or more massage heads 535, 540. Massage head silicone pads 520 are sized and shaped to fit with the massage head attachment portion.

### Example 4

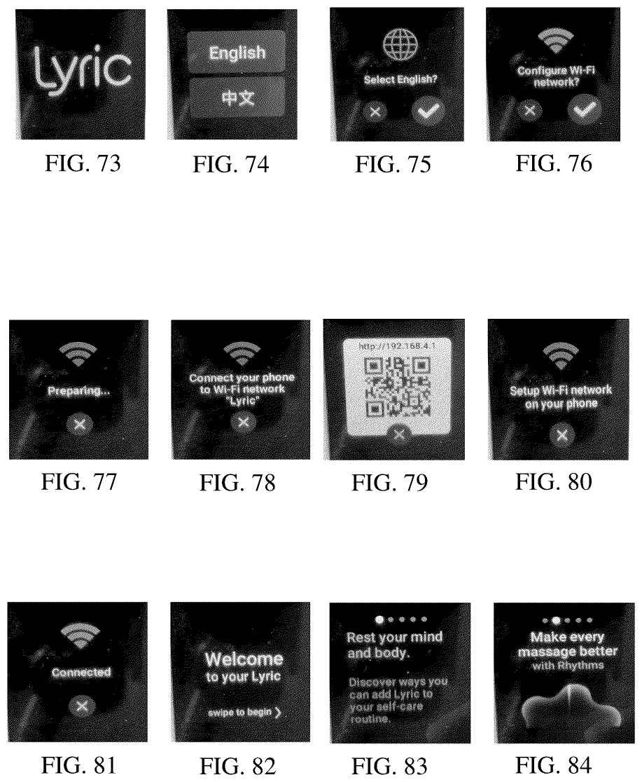

FIG. 73 illustrates a graphical user interface of a massager according to some embodiments of the disclosure. As shown in FIG. 73, the graphical user interface may comprise a boot-up screen comprising a brand name.

FIG. 74 illustrates a graphical user interface of a massager according to some embodiments of the disclosure. As shown in FIG. 74, the graphical user interface may comprise a choice of language. For example, the graphical user interface may offer the choice of English or one or more foreign languages. The massager associated with the graphical user interface may be adapted to receive input from a user of the massager to determine a desired language of operation.

FIG. 75 illustrates a graphical user interface of a massager according to some embodiments of the disclosure. As shown in FIG. 75, the graphical user interface may comprise a confirmation screen confirming the user's choice of desired language of operation.

FIG. 76 illustrates a graphical user interface of a massager according to some embodiments of the disclosure. As shown in FIG. 76, the graphical user interface may comprise a choice of whether to configure a Wi-Fi network. For example, the massager associated with the graphical user interface may be adapted to receive input from a user of the massager to determine whether to configure a Wi-Fi network.

FIG. 77 illustrates a graphical user interface of a massager according to some embodiments of the disclosure. As shown in FIG. 77, the graphical user interface may comprise a preparing screen. For example, the massager associated with the graphical user interface may be adapted to receive input from a user of the massager to cancel preparation.

FIG. 78 illustrates a graphical user interface of a massager according to some embodiments of the disclosure. As shown in FIG. 78, the graphical user interface may comprise an instructional screen. For example, the graphical user interface may instruct an associated user to connect a mobile device to a Wi-Fi network associated with the massager.

FIG. 79 illustrates a graphical user interface of a massager according to some embodiments of the disclosure. As shown in FIG. 79, the graphical user interface may comprise a quick response (QR) code screen. For example, the graphical user interface may display a QR code allowing an associated user to scan the QR code with their mobile device.

FIG. 80 illustrates a graphical user interface of a massager according to some embodiments of the disclosure. As shown in FIG. 8000, the graphical user interface may comprise an instructional screen. For example, the graphical user interface may instruct an associated user to set-up the Wi-Fi network on their mobile device. In some embodiments, the mobile device may have an application allowing the massager to receive instructions to join a given Wi-Fi network.

FIG. 81 illustrates a graphical user interface of a massager according to some embodiments of the disclosure. As shown in FIG. 81, the graphical user interface may comprise a connection screen. For example, the graphical user interface may indicate that the associated massager has been successfully connected to a Wi-Fi network.

FIG. 82 illustrates a graphical user interface of a massager according to some embodiments of the disclosure. As shown in FIG. 82, the graphical user interface may comprise an introduction screen. For example, the graphical user interface may display a welcome message and an instruction to begin use.

FIG. 83 illustrates a graphical user interface of a massager according to some embodiments of the disclosure. As shown in FIG. 83, the graphical user interface may comprise an informational screen. For example, the graphical user interface may indicate information about how to use the massager associated with the graphical user interface. In some embodiments, the graphical user interface may also comprise an indicator showing one screen selected of multiple.

FIG. 84 illustrates a graphical user interface of a massager according to some embodiments of the disclosure. As shown in FIG. 84, the graphical user interface may comprise an informational screen. For example, the graphical user interface may indicate information about how to use the massager associated with the graphical user interface. In some embodiments, the graphical user interface may also comprise an indicator showing one screen selected of multiple.

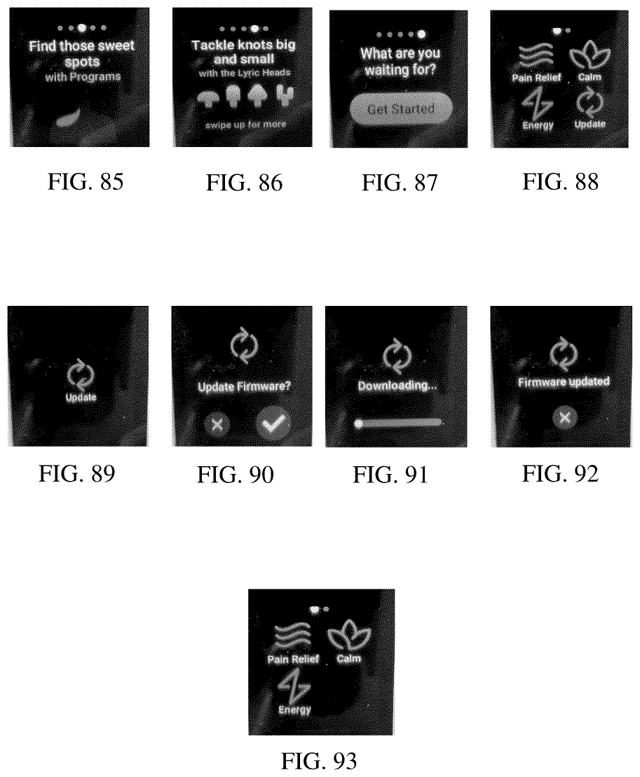

FIG. 85 illustrates a graphical user interface of a massager according to some embodiments of the disclosure. As shown in FIG. 85, the graphical user interface may comprise an informational screen. For example, the graphical user interface may indicate information about how to use the massager associated with the graphical user interface. In some embodiments, the graphical user interface may also comprise an indicator showing one screen selected of multiple.

FIG. 86 illustrates a graphical user interface of a massager according to some embodiments of the disclosure. As shown in FIG. 86, the graphical user interface may comprise an informational screen. For example, the graphical user interface may indicate information about how to use the massager associated with the graphical user interface. In some embodiments, the graphical user interface may also comprise an indicator showing one screen selected of multiple.

FIG. 87 illustrates a graphical user interface of a massager according to some embodiments of the disclosure. As shown in FIG. 87, the graphical user interface may comprise an introduction screen. For example, the graphical user interface may allow a user associated with the graphical user interface to send an input to get started using the massager associated with the graphical user interface. In some embodiments, the graphical user interface may also comprise an indicator showing one screen selected of multiple.

FIG. 88 illustrates a graphical user interface of a massager according to some embodiments of the disclosure. As shown in FIG. 88, the graphical user interface may comprise an options screen. For example, the graphical user interface may allow a user associated with the graphical user interface to select between options which may include pain relief, calm, energy, and update. In some embodiments, the graphical user interface may also comprise an indicator showing one screen selected of multiple.

FIG. 89 illustrates a graphical user interface of a massager according to some embodiments of the disclosure. As shown in FIG. 89, the graphical user interface may comprise an update screen. For example, the graphical user interface may indicate that an update is in progress or required.

FIG. 90 illustrates a graphical user interface of a massager according to some embodiments of the disclosure. As shown in FIG. 90, the graphical user interface may comprise a firmware update screen. For example, the graphical user interface may allow a user associated with the graphical user interface to select whether to update the firmware of a massager associated with graphical user interface.

FIG. 91 illustrates a graphical user interface of a massager according to some embodiments of the disclosure. As shown in FIG. 91, the graphical user interface may comprise a firmware downloading screen. For example, the graphical user interface may indicate that firmware is currently being downloaded on the massager associated with the graphical user interface. In some embodiments, the downloading screen may further comprise a progress bar based on the progress of the firmware update.

FIG. 92 illustrates a graphical user interface of a massager according to some embodiments of the disclosure. As shown in FIG. 92, the graphical user interface may comprise a firmware updated screen. For example, the graphical user interface indicate that the firmware of the massager associated with the graphical user interface has been updated.

FIG. 93 illustrates a graphical user interface of a massager according to some embodiments of the disclosure. As shown in FIG. 93, the graphical user interface may comprise an options screen. For example, the graphical user interface may allow a user associated with the graphical user interface to select between options which may include pain relief, calm, and energy. In some embodiments, the graphical user interface may also comprise an indicator showing one screen selected of multiple.

One embodiment may be a frequency-modulating massage device capable of executing therapy scripts, wherein a particular therapy script is selected and executed based on a consideration of a user's biometric criteria. The biometric criteria may be provided to the device through a combination of user input to the device (by, for example, touchpad, keypad, or mobile application), and direct device measurement of user biometric data. The device may measure user biometric data through various wearable data points, which may include sensors for monitoring the user's heart rate and blood pressure. Based on the real-time measuring of a user's biometric data, the device may alter and/or randomize its massage intensity, hindering muscle and nervous system adaptations, or “guarding,” ultimately promoting increased blood profusion to the affected soft tissue.

One embodiment may be a frequency-modulating therapeutic device that utilizes user-provided input, and device-measured biometric data to determine when and for how long a user needs to recover. In some embodiments, the user may wear health sensors that measure biometric data and communicate with the massage device. The health sensors may communicate with the massage device wirelessly or over a wired connection.

One embodiment may be a frequency-modulating therapeutic device that utilizes a Recovery Metric to weigh patient biometric data and determine an appropriate massage modulation response. The Recovery Metric may make use of the following factors:
Bₛₛ=Baseline Stress Score
Dₛ=Day of Usage Stress
Pₛ=Prior Evening Sleep
RPS=Rate of Perceived Exertion
HRV=Heart Rate Variability
TRIMP=Training Impulse Score
SLEEP=Sliding Scale Factor

In one embodiment, the Recovery Metric may use the Recovery Factors, outlined above, as part of the following formula:

(([(Bₛₛ/40)100]0.2)+([(Dₛ/10)100]0.1)+([(Pₛ/10)100]0.1))+[(RPS/10)100]0.3)+[HRV(0.1)]+[TRIMP(0.1)]+([(SLEEP/10)100]0.1)]

The formula is based on 100%. The formula may use a sliding scale model, and thus allow for all, none, or some of the data points to be used while still providing a base 100 score. Modifications to the formula assign different percentage values depending on whether some, all, or no variable points are available. The metric measure both objective biometric data as well as subjective psychosocial data to create a complex and dynamic measure of the body's stress levels.

In one embodiment, the massage device of the present disclosure may the Recovery Metric and user biometric data to calculate an appropriate massage modulation that rapidly varies the massage frequency and amplitude.

In one embodiment, the massage device of the present disclosure may be used with therapy scripts that are tailored for specific body parts. The following table provides, by way of example and not limitation, a selection of potential therapy scripts that may be executed. In the following table:
P—# is percussion pattern
Hz—Frequency Level (in Hertz)
S— time (in seconds)
Information—directions for percussive application and user motion.

| Body Part | Information | P-1 | P-2 | P-3 | P-4 | P-5 | P-6 | P-7 | P-8 |
|---|---|---|---|---|---|---|---|---|---|
| Rectus | Standing, in a split-stance with | Hz | Hz | Hz | Hz | Hz | Hz | Hz | Hz |
| abdominus | affected side leg behind. Place | 26.5, | 39.75, | 39.75, | 26.5, | 39.75, | 26.5, | 39.75, | 26.5, |
| | the Massager 1 finger width | Sec. | Sec. | Sec. | Sec. | Sec. | Sec. | Sec. | Sec. |
| | below ribs and 2 finger widths | 2 | 3 | 2 | 3 | 2 | 3 | 2 | 3 |
| | away from midline on your | | | | | | | | |
| | affected side abdominals. Glide | | | | | | | | |
| | the Massager down and toward | | | | | | | | |
| | midline ending 3 finger widths | | | | | | | | |
| | below the belly button while | | | | | | | | |
| | extending your back ~10-15°. | | | | | | | | |
| Gastrocnemius | Standing in a split stance with | Hz | Hz | Hz | Hz | Hz | Hz | Hz | Hz |
| | your affected leg back and | 37.0 | 45.05 | 31.8, | 45.05 | 31.8, | 31.8, | 45.05 | 21.2, |
| | slightly flexed ~20°. Locate the | Sec. | Sec. | Sec. | Sec. | Sec. | Sec. | Sec. | Sec. |
| | back of the knee (popliteal fossa) | 1 | 2 | 2 | 1 | 2 | 2 | 1 | 4 |
| | and place the Massager just | | | | | | | | |
| | below on the outside of the calf | | | | | | | | |
| | muscle. Glide the Massager | | | | | | | | |
| | down the length of the calf to the | | | | | | | | |
| | achilles tendon while extending | | | | | | | | |
| | the leg and keeping the foot | | | | | | | | |
| | planted on the ground. | | | | | | | | |
| Gluteus | Stand with your affected foot up | Hz | Hz | Hz | Hz | Hz | Hz | Hz | Hz |
| Medius | on a chair or bench. Locate your | 53 | 47.7 | 53 | 47.7 | 53 | 47.7 | 53 | 47.7 |
| | femoral head, ~8 finger widths | Sec. | Sec. | Sec. | Sec. | Sec. | Sec. | Sec. | Sec. |
| | from the crest of the hip; place | 2 | 3 | 2 | 3 | 2 | 3 | 2 | 3 |
| | the Massager just posterior of | | | | | | | | |
| | the femoral head toward the | | | | | | | | |
| | buttocks. Glide the Massager | | | | | | | | |
| | through the length of the gluteus | | | | | | | | |
| | medius ending 2 finger widths | | | | | | | | |
| | before the midline while lunging | | | | | | | | |
| | forward and using unaffected | | | | | | | | |
| | side hand pull affected side leg | | | | | | | | |
| | across body. | | | | | | | | |

One embodiment may be a method of using a frequency-modulating therapeutic device, comprising the steps:
providing a frequency modulating therapeutic device;
wherein the frequency modulating therapeutic device may be portable, handheld, and comprises a massage head, and/or may be a fixed device, such as a massage chair or boot;
providing a biometric data entry user interface;
wherein the user interface allows for a user to enter biometric baseline data related to any combination of the following health parameters: baseline stress score, day of usage stress, prior evening sleep, rate of perceived exertion, and heart rate variability;
executing a massage therapy script;
wherein the therapeutic device continuously monitors the user's biometric data during massage script execution, by means of health sensors equipped to the user.

In one embodiment, a user may, through an appropriate GUI (graphical user interface), input user biometric data to the device. For example, a user may provide information about the user's baseline stress score, day of usage stress, prior evening sleep, rate of perceived exertion, heart rate variability, and training impulse score. After receiving the user-inputted biometric data, the massage device may use the Recovery Metric to determine an appropriate therapeutic script. The device may either select from a bank of existing therapeutic scripts saved to the device, or may calculate a new script in the moment, particularized to the specific user's biometric data.

During therapeutic script execution, the massage device may continue to monitor the patient's biometric data, using biometric data gathered from appropriate sensors worn by the user, to modulate its massage pattern in real-time. The Recovery Metric similarly guides the device in its process of modulating the massage script. Preferably, the massage device rapidly changes its frequency and amplitude, approximately every 2.0-4.0 seconds, in order to effectively hinder the ability of the muscle and nervous systems to adapt through “muscle guarding,” resulting in increased blood-tissue profusion and therapeutic effect in the targeted area. In addition to varying the percussive frequency and amplitude, the device, if equipped with an electrical stimulation unit, may similarly modulate the electric discharge provided by the electrical stimulation unit.

In one embodiment, the device of the present disclosure may have an operating system capable of receiving massage/heating algorithms authored from a software application that either resides on a server and/or resident on a device. Memory on the device capable of storing the algorithms received by wireless, wired, or memory card. The device may have a motor capable of adjusting the length of Percussion and Vibration patterns. The rod adjustment sends different percussion and vibration notes to the body. Shorter rods generate more vibration, longer rods generate more percussion. The purpose of this device/system is to increase the amplitude/pattern so that the muscles are stimulated even closer to what a practitioner would administer on an actual patient with soft tissue work by the hands. In many cases, because of the adjustable head and programmable massage algorithms, the system of the present disclosure may go above and beyond what human hands do to further improve the manipulation of soft tissue so that muscle recovery can accelerate.

In some embodiments, massager may include Rhythm Therapy. Rather than a mono-frequency or “flat line” experience, which is what most massage devices deliver, the massager may vibrate in a wavelike pattern that mimics naturally occurring rhythms that have a profound impact on the body and mind. Rhythm is deeply human and connected to a person's ability to relax, calm, renew and invigorate. Rhythm promotes a feeling of happiness; it helps to center and connect the mind and body. Rhythm helps people to be fully well.

Alternating frequencies have been shown to affect the endocrine, musculoskeletal and nervous systems. Vibrations delivered by the massager may utilize fluctuating frequencies while incorporating vibroacoustic science to temporarily alleviate minor muscle pain, shift stress and positively affect both emotions and overall mental state.

The massager may allow for a therapeutic range of frequencies coupled with lower amplitude (the distance traveled by the massage head). This combination may require less pressure from the massager to achieve the same benefit, allowing for a comfortable, enjoyable and nonaggressive massage experience that feels good and promotes positive wellbeing.

The massage may comprise a slim handle with ergonomic grip and may include an extension handle for easier maneuvering and access to hard-to-reach spots. The massager may further comprise an induction charger, incorporated as part of the docking station.

Unless otherwise stated, all measurements, values, ratings, positions, magnitudes, sizes, locations, and other specifications, which set forth in this specification, including in the claims that follow, are approximate, not exact. They are intended to have a reasonable range, which is consistent with the functions to which they relate and with what is customary in the art to which they pertain.

In addition, the various illustrative logical blocks, modules, and circuits described in connection with certain embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, system-on-a-chip, or state machine. A processor may also be implemented as a combination of computing devices, e.g., a combination of a DSP and a microprocessor, a plurality of microprocessors, one or more microprocessors in conjunction with a DSP core, or any other such configuration.

Operational embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD disk, or any other form of storage medium known in the art. An exemplary storage medium is coupled to the processor such the processor may read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed embodiments. Non-transitory computer readable media may include but are not limited to magnetic storage devices (e.g., hard disk, floppy disk, magnetic strips), optical disks (e.g., compact disk (CD), digital versatile disk (DVD)), smart cards, and flash memory devices (e.g., card, stick). Those skilled in the art will recognize many modifications may be made to this configuration without departing from the scope of the disclosed embodiments.

The foregoing description of the preferred embodiment has been presented for the purposes of illustration and description. While multiple embodiments are disclosed, still other embodiments will become apparent to those skilled in the art from the above detailed description, which shows and describes the illustrative embodiments. As will be realized, these embodiments are capable of modifications in various obvious aspects, all without departing from the spirit and scope of the present disclosure. Accordingly, the detailed description is to be regarded as illustrative in nature and not restrictive. Also, although not explicitly recited, one or more additional embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

### Numbered Embodiments

Set 1
1. A massager comprising:
   a power source;
   a motor;
   a counterweight cam;
   a transmission shaft;
   mechanism wherein the motor mechanism comprises a shaft that is lazy Z-shaped;
   a housing;
   one or more massage head attachment portions; and
   a display.
2. The massager of embodiment 1, wherein the transmission shaft is lazy Z-shaped.
3. The massager of embodiment 1, wherein the power source is a battery.
4. The massager of embodiment 3, wherein the battery and the motor are on opposite ends of the massager.
5. The massager of embodiment 1, further comprising one or more damping elements wherein the damping elements substantially reduce a noise level made by the massager when in use.
6. The massager of embodiment 1, wherein the display is configured to display massage information to a user.
7. The massager of embodiment, wherein the massage information consists of information selected from the group of information consisting of one or more of: a graphical depiction of a body; a graphical depiction of a body part; a body part indicator; a body part area indicator; a directional indicator; a proposed power indicator; an actual power indicator; a timer bar; instructions on how to use the massager; listing massage programs; selecting massage programs; massage program indicators; a battery indicator; and combinations thereof.
8. The massager of embodiment 1, wherein the display is a touch screen display.
9. The massager of embodiment 1, wherein the display is a light emitting diode display.
10. The massager of embodiment 1, wherein the display is configured to automatically darken when not in use.
11. The massager of embodiment 1, wherein the massager is provided with a recovery metric for a user and a plurality of user biometric data;
   wherein the massager is configured to use the recovery metric and the plurality of user biometric data to calculate a massage modulation that rapidly varies the massage frequency and amplitude during use.
12. The massager of embodiment 1, wherein the massager is configured to play one or more massage therapy scrips.
13. The massager of embodiment 1, further comprising one or more extension handles;
   wherein the one or more extension handles are configured to matingly and magnetically attach to an end of the massager.
14. A massager comprising:
   a rechargeable battery;
   a motor;
   a counterweight cam;
   a transmission shaft that is lazy Z-shaped;
   mechanism wherein the motor mechanism comprises a shaft that is lazy Z-shaped;
   a housing;
   a piston;
   an operations button;
   one or more damping elements;
   one or more massage head attachment portions; and
   a display;
   wherein the transmission shaft is lazy Z-shaped;
   wherein the battery and the motor are on opposite ends of the massager; and
   wherein the motor is operatively connected to the counterbalance cam, which is operatively connected to the transmission shaft, which is operatively connected to the piston, which is operatively connected to one of the one or more massage head attachment portions.
15. The massager of embodiment 14, wherein the display is configured to display massage information to a user.
16. The massager of embodiment 15, wherein the massage information consists of information selected from the group of information consisting of one or more of: a graphical depiction of a body; a graphical depiction of a body part; a body part indicator; a body part area indicator; a directional indicator; a proposed power indicator; an actual power indicator; a timer bar; instructions on how to use the massager; listing massage programs; selecting massage programs; massage program indicators; a battery indicator; and combinations thereof.
17. The massager of embodiment 14, wherein the display is a touch screen display.
18. The massager of embodiment 14, wherein the display is a light emitting diode display.
19. The massager of embodiment 14, wherein the display is configured to automatically darken when not in use.
20. The massager of embodiment 14, wherein the massager is provided with a recovery metric for a user and a plurality of user biometric data;
   wherein the massager is configured to use the recovery metric and the plurality of user biometric data to calculate a massage modulation that rapidly varies the massage frequency and amplitude during use.
21. The massager of embodiment 14, wherein the massager is configured to play one or more massage therapy scrips.
22. The massager of embodiment 14, further comprising one or more extension handles;
   wherein the one or more extension handles are configured to matingly and magnetically attach to an end of the massager.
23. A compact massager, comprising:
   (1) one or more massage head attachment portions; and
   (2) a massager body, having a top body end, and an opposing, bottom body end defining a length therebetween, and a front body side and a rear body side defining a cross-section therewithin,
      wherein the massager body is configured to connect with the one or more massage head attachment portions at the front body side, the massager body further comprises:
      (i) a motor, disposed proximate to the top body end;
      (ii) a PCBA, disposed proximate to the bottom body end;
      (iii) a display, disposed at the rear body side;
      (iv) a power source, disposed proximate to the bottom body end;
      wherein the power source is configured to electrically connect with the motor, the PCBA and the display;
      (v) a Z-shaped, transmission crank, configured to translate rotary motion from the motor to reciprocating motion of the one or more massage head attachment portions; and
      (vi) a counterweight, having an eccentric cam, an input shaft and an output shaft,
      wherein the input shaft is disposed at one side of the cam and is operatively connected to the motor, and an output shaft is disposed at an opposing side of the cam and is operatively connected to the transmission crank.
24. The compact massager of embodiment 23, wherein the transmission crank further comprises a first annular portion, a second annular portion and a z-shaped crank shaft portion, the first annular portion is configured to operatively connect with the output shaft and has an inner annular diameter larger than an outer diameter of the output shaft, and the second annular portion is configured to connect with the one or more massage head attachment portions.
25. The compact massager of embodiment 24, wherein the crank shaft portion further comprises a first linear portion, a second linear portion and a third linear portion, the first linear portion connects with the second linear portion at an angle of 70-105 degree, the third linear portion connects with the second annular portion, and the first linear portion and the third linear portion are parallel to each other.
26. The compact massager of embodiment 23, wherein the cam is in a truncated circular shape and both the input shaft and the output shaft are disposed proximate to a truncated side of the cam.
27. The compact massager of embodiment 26, wherein an axial axis of the output shaft is closer to the truncated side than that of the input shaft.
28. The massager of embodiment 23, further comprising a housing for receiving the massager body, the housing has a substantially uniform overall cross-section along the length.
29. The compact massager of embodiment 28, wherein the housing is formed by a front cover and a rear cover, the front cover and the rear cover are configured to connect together along the length.
30. The compact massager of embodiment 29, wherein the front cover is configured to receive the one or more massage head attachment portions.
31. The compact massager of embodiment 23, further comprising a frame having a top frame end, an opposing, bottom frame end, a front frame side and a rear frame side, wherein the frame is configured to receive the motor proximate to the top frame end at the front frame side, and to receive the power source proximate to the bottom frame end at the front frame side.
32. The compact massager of embodiment 31, wherein the frame is further configured to receive the PCBA at the front frame side.
33. The compact massager of embodiment 31, wherein the frame is further configured to receive the display at the rear frame side.
34. The compact massager of embodiment 31, further comprising a motor rack connected with the frame and at least a bottom portion of the motor.
35. The compact massager of embodiment 34, wherein the motor rack is fixedly connected with at least the bottom portion of the motor by a plurality of screws, and each of the screws is provided with a silicone ring.
36. The compact massager of embodiment 34, wherein the motor rack further comprises a plurality of damping pads.
37. The compact massager of embodiment 23, wherein the power source is a re-chargeable battery.
38. The compact massager of embodiment 23, further comprising a piston operatively connected with the transmission crank and the one or more massage head attachment portions, the piston further comprises one or more damping sleeves, wherein the damping sleeves substantially reduce a noise level made by the massager when in use.
39. The compact massager of embodiment 23, wherein the display is a touch screen display and/or a light emitting diode display.
40. The compact massager of embodiment 23, wherein the display is configured to automatically darken when not in use.
41. The compact massager of embodiment 23, wherein the massager is provided with a recovery metric for a user and a plurality of user biometric data, wherein the massager is configured to use the recovery metric and the plurality of user biometric data to calculate a massage modulation that rapidly varies the massage frequency and amplitude during use.
42. The compact massager of embodiment 23, wherein the compact massager is configured to play one or more massage therapy scrips.
43. The compact massager of embodiment 23, further comprising one or more extension handles;
   wherein the one or more extension handles are configured to matingly and optionally magnetically attach to the bottom body end.
44. A compact massager, having a top end and a bottom end defining a length therebetween, a front side and a rear side defining a cross-section therewithin, comprising:
   a rechargeable battery, disposed proximate to the bottom end;
   a motor, disposed proximate to the top end;
   a counterweight;
   a transmission crank that is Z-shaped;
   a housing for receiving the massager body that has substantially uniform overall cross-section along the length;
   a piston;
   an operations button;
   one or more damping pads;
   one or more massage head attachment portions; and
   a display;
   wherein the battery is configured to electrically connect with the motor, the operations button and the display; and
   wherein the motor is operatively connected to the counterweight, which is operatively connected to the transmission crank, which is operatively connected to the piston, which is operatively connected to one of the one or more massage head attachment portions.

Set 2
1. An massager system, comprising:
   a massager, comprising:
      a housing, comprising a housing front face and an opposing housing back face;
      a battery, received within the housing;
      a massage head attachment portion, disposed at the housing front face and attachable to a massage head; and
      a motor, received within the housing and connected with the battery and the massage head attachment portion to drive the massage head attached on the massage head attachment portion; and
   a dock, comprising a dock front face and an opposing dock back face, the dock front face comprising a recess,
   wherein the dock is configured to engage with the massager, size and shape of at least a portion of the dock front face matches with the housing front face, such that the dock hides and protects the massage head attached on the massage head attachment portion when docking with the massager.
2. The massager system of embodiment 1, further comprising a detachable, extension handle which comprises a magnetic connection portion configured to snap fit to the housing, and the shape of the extension handle is consistent with the connection portion of the massager for seamless aesthetic and user ergonomics.
3. The massager system of embodiment 2, wherein the extension handle further comprises a control button electrically connected with the massager to control the massager.
4. The massager system of embodiment 1, further comprising at least one exchangeable massager head.
5. The massager system of embodiment 4, wherein the at least one exchangeable massager head further comprises magnetic attachment piece configured to exchangeably attach with the massage head attachment portion.
6. The massager system of embodiment 4, wherein shape of the at least one exchangeable massager head is one or more of semi-circular, rounded head cylindrical or double rounded head cylindrical.
7. The massager system of embodiment 4, wherein the dock back face further comprises a removable tray which matches the dock in size and shape, and the removable tray is configured as receiving at least one exchangeable massage head.
8. The massager system of embodiment 7, wherein the removable tray further configured as a stand to a mobile.
9. The massager system of embodiment 1, further comprising:
   a body scan device configured to scan a body of a user for pain points.
10. The massager system of embodiment 1, wherein the dock matches with the massager in size and shape to provide aesthetic of one cohesive unit.
11. The massager system of embodiment 1, wherein the massager further comprises a user interface, the user interface is a screen that displays easy to follow visual and text instructions on how to perform massage.
12. The massager system of embodiment 1, wherein the battery is a rechargeable battery, the dock further comprises a wireless charging transmission coil to charge the battery wirelessly.
13. The massager system of embodiment 1, further comprising an elastic band to fix the massager system when the massager engages with the dock.
14. The massager system of embodiment 1, wherein the massager further comprises a voice receiving device configured to receive user voice to activate and control the massager.
15. The massager system of embodiment 1, wherein the massager further comprises a mobile wireless linking device to remotely control the massager via a mobile.
16. The massager system of embodiment 11, wherein the user interface is a touch screen display.
17. The massager system of embodiment 16, wherein the touch screen display is dimmable.
18. The massager system of embodiment 16, wherein the touch screen display has a rubberized tinted or translucent coating that is color-matched with the rest of the massager.
19. The massager system of embodiment 1, wherein the button is a recessed trigger button.
20. A massager system, comprising:
   a massager, comprising:
      a housing, comprising a housing front face and an opposing housing back face;
      a rechargeable battery, received within the housing;
      a massage head attachment portion, disposed at the housing front face and attachable to a massage head; and
      a motor, received within the housing and connected with the battery and the massage head attachment portion to drive the massage head attached on the massage head attachment portion;
      a button, disposed at the housing front face, the button being a recessed trigger button; and
      a user interface, disposed at the housing back face, the user interface being a touch screen display;
   a dock, comprising a dock front face and an opposing dock back face, the dock front face comprising a recess, the dock back face further comprising a wireless charging
   transmission coil to wirelessly charge the battery and a removable tray, the removable tray matches the dock in size and shape, and is configured as receiving at least one exchangeable massage head; and
   at least one exchangable massage head;
   wherein the dock is configured to engage with the massager, size and shape of at least a portion of the dock front face matches with the housing front face, such that the dock hides and protects the massage head attached on the massage head attachment portion when docking with the massager.

Set 3
1. An improved massager, comprising:
   a housing, comprising a housing front face and an opposing, housing back face;
   a rechargeable battery, received within the housing;
   an massage head attachment portion, disposed at the housing front face and attachable to a massage head;
   a motor, received within the housing and eclectically connected with the battery and the massage head attachment portion to drive the massage head attached on the massage head attachment portion;
   a button, disposed at the housing front face, the button being a recessed trigger button; and a display, disposed at the housing back face;
   wherein the display is configured to display massage information.
2. The improved massager of embodiment 1, wherein the massage information comprises at least one of the following: a graphical depiction of a body or body part; a body part indicator; a body part area indicator; a directional indicator; a proposed power indicator; an actual power indicator; and a battery indicator.
3. The improved massager of embodiment 1 or 2, wherein the display is a touch screen display
4. The improved massager of any one of embodiments 1-3, wherein the display is an LED display.
5. The improved massager of any one of embodiments 1-4, wherein the display is a screen that displays easy to follow visual and text instructions on how to perform massage.

What is claimed is:

1. A compact massager, comprising:
(1) one or more massage head attachment portions; and
(2) a massager body, having a top body end, and an opposing, bottom body end defining a length therebetween, and a front body side and a rear body side defining a cross-section therewithin,
wherein the massager body is configured to connect with the one or more massage head attachment portions at the front body side, the massager body further comprises:
(i) a motor, disposed proximate to the top body end;
(ii) a PCBA, disposed proximate to the bottom body end;
(iii) a display, disposed at the rear body side;
(iv) a power source, disposed proximate to the bottom body end;
wherein the power source is configured to electrically connect with the motor, the PCBA and the display;
(v) a Z-shaped, transmission crank, configured to translate rotary motion from the motor to reciprocating motion of the one or more massage head attachment portions; and
(vi) a counterweight, having an eccentric cam, an input shaft and an output shaft,
wherein the input shaft is disposed at one side of the cam and is operatively connected to the motor, and an output shaft is disposed at an opposing side of the cam and is operatively connected to the transmission crank.

2. The compact massager of claim 1, wherein the transmission crank further comprises a first annular portion, a second annular portion and a z-shaped crank shaft portion, the first annular portion is configured to operatively connect with the output shaft and has an inner annular diameter larger than an outer diameter of the output shaft, and the second annular portion is configured to connect with the one or more massage head attachment portions.

3. The compact massager of claim 2, wherein the crank shaft portion further comprises a first linear portion, a second linear portion and a third linear portion, the first linear portion connects with the second linear portion at an angle of 70-105 degree, the third linear portion connects with the second annular portion, and the first linear portion and the third linear portion are parallel to each other.

4. The compact massager of claim 1, wherein the cam is in a truncated circular shape and both the input shaft and the output shaft are disposed proximate to a truncated side of the cam.

5. The compact massager of claim 4, wherein an axial axis of the output shaft is closer to the truncated side than that of the input shaft.

6. The massager of claim 1, further comprising a housing for receiving the massager body, the housing has a substantially uniform overall cross-section along the length.

7. The compact massager of claim 6, wherein the housing is formed by a front cover and a rear cover, the front cover and the rear cover are configured to connect together along the length.

8. The compact massager of claim 7, wherein the front cover is configured to receive the one or more massage head attachment portions.

9. The compact massager of claim 1, further comprising a frame having a top frame end, an opposing, bottom frame end, a front frame side and a rear frame side, wherein the frame is configured to receive the motor proximate to the top frame end at the front frame side, and to receive the power source proximate to the bottom frame end at the front frame side.

10. The compact massager of claim 9, wherein the frame is further configured to receive the PCBA at the front frame side.

11. The compact massager of claim 9, wherein the frame is further configured to receive the display at the rear frame side.

12. The compact massager of claim 9, further comprising a motor rack connected with the frame and at least a bottom portion of the motor.

13. The compact massager of claim 12, wherein the motor rack is fixedly connected with at least the bottom portion of the motor by a plurality of screws, and each of the screws is provided with a silicone ring.

14. The compact massager of claim 12, wherein the motor rack further comprises a plurality of damping pads.

15. The compact massager of claim 1, wherein the power source is a re-chargeable battery.

16. The compact massager of claim 1, further comprising a piston operatively connected with the transmission crank and the one or more massage head attachment portions, the piston further comprises one or more damping sleeves, wherein the damping sleeves substantially reduce a noise level made by the massager when in use.

17. The compact massager of claim 1, wherein the display is a touch screen display and/or a light emitting diode display.

18. The compact massager of claim 1, wherein the display is configured to automatically darken when not in use.

19. The compact massager of claim 1, wherein the massager is provided with a recovery metric for a user and a plurality of user biometric data,
wherein the massager is configured to use the recovery metric and the plurality of user biometric data to calculate a massage modulation that rapidly varies the massage frequency and amplitude during use.

20. The compact massager of claim 1, wherein the compact massager is configured to play one or more massage therapy scrips.

21. The compact massager of claim 1, further comprising one or more extension handles; wherein the one or more extension handles are configured to matingly and optionally magnetically attach to the bottom body end.

22. A compact massager, having a top end and a bottom end defining a length therebetween, a front side and a rear side defining a cross-section therewithin, comprising:
a rechargeable battery, disposed proximate to the bottom end;
a motor, disposed proximate to the top end;
a counterweight;
a transmission crank that is Z-shaped;
a housing for receiving the massager body that has substantially uniform overall cross-section along the length;
a piston;
an operations button;
one or more damping pads;
one or more massage head attachment portions; and
a display;
wherein the battery is configured to electrically connect with the motor, the operations button and the display; and
wherein the motor is operatively connected to the counterweight, which is operatively connected to the transmission crank, which is operatively connected to the piston, which is operatively connected to one of the one or more massage head attachment portions.
